(19) United States
(12) Patent Application Publication
(10) Pub. No.: US 2026/0073080 A1
(43) Pub. Date: Mar. 12, 2026

(54) RESPONDING TO INPUTS

(71) Applicant: Apple Inc., Cupertino, CA (US)

(72) Inventors: Nikolas J. GELO, San Jose, CA (US); Nicholas D. LUPINETTI, Oakland, CA (US); Neil N. DESAI, San Francisco, CA (US); Neil G. CRANE, San Francisco, CA (US); Andrew J. DESJARLAIS, Poway, CA (US); Bradley D. FORD, San Jose, CA (US); Elliott B. HARRIS, San Francisco, CA (US); Jamal YAUHARI MARTINEZ, San Francisco, CA (US); Russell A. BLAINE, San Carlos, CA (US)

(21) Appl. No.: 19/201,110

(22) Filed: May 7, 2025

Related U.S. Application Data
(60) Provisional application No. 63/692,114, filed on Sep. 8, 2024.

(51) Int. Cl. G06F 21/62; H04N 23/63; H04N 23/69

(52) U.S. Cl. CPC G06F 21/629; H04N 23/631; H04N 23/69

(57) ABSTRACT

The present disclosure generally relates to responding to inputs. Some techniques are for separately notifying different processes in accordance with some embodiments. Other techniques are for passing through requests in accordance with some embodiments. Other techniques are for out-of-band changes in accordance with some embodiments. Other techniques are for updating settings in accordance with some embodiments.

### CROSS-REFERENCE TO RELATED APPLICATIONS

This application claims priority to U.S. Provisional Patent Application Ser. No. 63/692,114, entitled “RESPONDING TO INPUTS” filed Sep. 8, 2024, which is hereby incorporated by reference in its entirety for all purposes.

### BACKGROUND

Devices often have client applications that use hardware components, such as microphones and cameras, to provide users with services. Enabling the client applications to take full advantage of features provided by the devices with respect to the hardware components can be difficult. Accordingly, there is a need to improve techniques for integrating client applications, hardware components, and device features.

### SUMMARY

Current techniques for integrating client applications, hardware components, and device features are generally ineffective and/or inefficient. For example, some techniques require client applications to be updated when any new hardware component is added to a device. This disclosure provides more effective and/or efficient techniques for integrating client applications, hardware components, and device features using system processes that provide Application Programming Interfaces (APIs) for initiating objects within a process of an application for handling configuration, synchronization, and/or communication with the system processes. It should be recognized that such APIs are an example of how techniques described herein can be implemented and that other software mechanisms can be used, such as applications using (1) APIs to directly communicate with system processes and/or (2) other types of communication.

Some techniques are described herein for an application to communicate with multiple, different system processes when detecting an input. Such communication can include requesting updates using communication with one system process and notifying of the updates using communication with another system process. Other techniques are described herein for an application to configure a system process to modify settings that affect the application on behalf of the application through a mechanism that requires communication back to the application. The mechanism can include the application communicating with the same process when modifying the settings for the system process and as the application would when the application is modifying the settings on its own. Other techniques are described herein for an application to configure a system process to modify settings that affect the application on behalf of the application through a mechanism that does not require communication back to the application before the settings are modified by the system process. Instead, the application receives a notification when the settings have been changed by the system process. Other techniques are described herein for a system process to manage a system control that is capable of modifying settings corresponding to different applications. The system process ensures that the application is updated when any modifications are made and/or any system user interfaces are displayed.

In some embodiments, a method that is performed at a device, by an application of the device, that is in communication with one or more display generation components and one or more input devices is described. In some embodiments, the method comprises: while a user interface corresponding to the application is displayed via the one or more display generation components, detecting, via the one or more input devices, an input; and in response to detecting the input: sending, to a first system process of the device, a first notification of the input, wherein the first system process is separate from the application; and sending, to a second system process of the device, a second notification of the input, wherein the second system process is separate from the first system process and the application, and wherein the second notification is separate from the first notification.

In some embodiments, a non-transitory computer-readable storage medium storing one or more programs configured to be executed by one or more processors of a device, by an application of the device, that is in communication with one or more display generation components and one or more input devices is described. In some embodiments, the one or more programs includes instructions for: while a user interface corresponding to the application is displayed via the one or more display generation components, detecting, via the one or more input devices, an input; and in response to detecting the input: sending, to a first system process of the device, a first notification of the input, wherein the first system process is separate from the application; and sending, to a second system process of the device, a second notification of the input, wherein the second system process is separate from the first system process and the application, and wherein the second notification is separate from the first notification.

In some embodiments, a transitory computer-readable storage medium storing one or more programs configured to be executed by one or more processors of a device, by an application of the device, that is in communication with one or more display generation components and one or more input devices is described. In some embodiments, the one or more programs includes instructions for: while a user interface corresponding to the application is displayed via the one or more display generation components, detecting, via the one or more input devices, an input; and in response to detecting the input: sending, to a first system process of the device, a first notification of the input, wherein the first system process is separate from the application; and sending, to a second system process of the device, a second notification of the input, wherein the second system process is separate from the first system process and the application, and wherein the second notification is separate from the first notification.

In some embodiments, a device, by an application of the device, configured to communicate with one or more display generation components and one or more input devices is described. In some embodiments, the device comprises one or more processors and memory storing one or more programs configured to be executed by the one or more processors. In some embodiments, the one or more programs includes instructions for: while a user interface corresponding to the application is displayed via the one or more display generation components, detecting, via the one or more input devices, an input; and in response to detecting the input: sending, to a first system process of the device, a first notification of the input, wherein the first system process is separate from the application; and sending, to a second system process of the device, a second notification of the input, wherein the second system process is separate from the first system process and the application, and wherein the second notification is separate from the first notification.

In some embodiments, a device, by an application of the device, configured to communicate with one or more display generation components and one or more input devices is described. In some embodiments, the device comprises means for performing each of the following steps: while a user interface corresponding to the application is displayed via the one or more display generation components, detecting, via the one or more input devices, an input; and in response to detecting the input: sending, to a first system process of the device, a first notification of the input, wherein the first system process is separate from the application; and sending, to a second system process of the device, a second notification of the input, wherein the second system process is separate from the first system process and the application, and wherein the second notification is separate from the first notification.

In some embodiments, a computer program product is described. In some embodiments, the computer program product comprises one or more programs configured to be executed by one or more processors of a device, by an application of the device, that is in communication with one or more display generation components and one or more input devices. In some embodiments, the one or more programs include instructions for: while a user interface corresponding to the application is displayed via the one or more display generation components, detecting, via the one or more input devices, an input; and in response to detecting the input: sending, to a first system process of the device, a first notification of the input, wherein the first system process is separate from the application; and sending, to a second system process of the device, a second notification of the input, wherein the second system process is separate from the first system process and the application, and wherein the second notification is separate from the first notification.

In some embodiments, a method that is performed at a device, by an application of the device, that is in communication with one or more display generation components is described. In some embodiments, the method comprises: displaying, via the one or more display generation components, a user interface corresponding to the application; while displaying the user interface corresponding to the application, receiving, from a first system process of the device, a first request to change a setting corresponding to the user interface, wherein the first system process is separate from the application; and in response to receiving the request to change the setting corresponding to the user interface, sending, to a second system process of the device, a second request to change the setting corresponding to the user interface, wherein the second system process is separate from the first system process and the application.

In some embodiments, a non-transitory computer-readable storage medium storing one or more programs configured to be executed by one or more processors of a device, by an application of the device, that is in communication with one or more display generation components is described. In some embodiments, the one or more programs includes instructions for: displaying, via the one or more display generation components, a user interface corresponding to the application; while displaying the user interface corresponding to the application, receiving, from a first system process of the device, a first request to change a setting corresponding to the user interface, wherein the first system process is separate from the application; and in response to receiving the request to change the setting corresponding to the user interface, sending, to a second system process of the device, a second request to change the setting corresponding to the user interface, wherein the second system process is separate from the first system process and the application.

In some embodiments, a transitory computer-readable storage medium storing one or more programs configured to be executed by one or more processors of a device, by an application of the device, that is in communication with one or more display generation components is described. In some embodiments, the one or more programs includes instructions for: displaying, via the one or more display generation components, a user interface corresponding to the application; while displaying the user interface corresponding to the application, receiving, from a first system process of the device, a first request to change a setting corresponding to the user interface, wherein the first system process is separate from the application; and in response to receiving the request to change the setting corresponding to the user interface, sending, to a second system process of the device, a second request to change the setting corresponding to the user interface, wherein the second system process is separate from the first system process and the application.

In some embodiments, a device, by an application of the device, configured to communicate with one or more display generation components is described. In some embodiments, the device comprises one or more processors and memory storing one or more programs configured to be executed by the one or more processors. In some embodiments, the one or more programs includes instructions for: displaying, via the one or more display generation components, a user interface corresponding to the application; while displaying the user interface corresponding to the application, receiving, from a first system process of the device, a first request to change a setting corresponding to the user interface, wherein the first system process is separate from the application; and in response to receiving the request to change the setting corresponding to the user interface, sending, to a second system process of the device, a second request to change the setting corresponding to the user interface, wherein the second system process is separate from the first system process and the application.

In some embodiments, a device, by an application of the device, configured to communicate with one or more display generation components is described. In some embodiments, the device comprises means for performing each of the following steps: displaying, via the one or more display generation components, a user interface corresponding to the application; while displaying the user interface corresponding to the application, receiving, from a first system process of the device, a first request to change a setting corresponding to the user interface, wherein the first system process is separate from the application; and in response to receiving the request to change the setting corresponding to the user interface, sending, to a second system process of the device, a second request to change the setting corresponding to the user interface, wherein the second system process is separate from the first system process and the application.

In some embodiments, a computer program product is described. In some embodiments, the computer program product comprises one or more programs configured to be executed by one or more processors of a device, by an application of the device, that is in communication with one or more display generation components. In some embodiments, the one or more programs include instructions for: displaying, via the one or more display generation components, a user interface corresponding to the application; while displaying the user interface corresponding to the application, receiving, from a first system process of the device, a first request to change a setting corresponding to the user interface, wherein the first system process is separate from the application; and in response to receiving the request to change the setting corresponding to the user interface, sending, to a second system process of the device, a second request to change the setting corresponding to the user interface, wherein the second system process is separate from the first system process and the application.

In some embodiments, a method that is performed at a device, by an application of the device, that is in communication with one or more display generation components and one or more input devices is described. In some embodiments, the method comprises: while a user interface corresponding to the application is displayed via the one or more display generation components, receiving, from a system process of the device, an indication that a setting corresponding to the user interface has been changed from a first state to a second state on behalf of the application without the application requesting the setting to be changed, wherein the system process is separate from the application, and wherein the second state is different from the first state; after receiving the indication that the setting corresponding to the user interface has been changed from the first state to the second state on behalf of the application without the application requesting the setting to be changed, detecting, via the one or more input devices, an input corresponding to a request to change the setting; and in response to detecting the input corresponding to the request to change the setting, changing the setting from the second state to a third state different from the second state.

In some embodiments, a non-transitory computer-readable storage medium storing one or more programs configured to be executed by one or more processors of a device, by an application of the device, that is in communication with one or more display generation components and one or more input devices is described. In some embodiments, the one or more programs includes instructions for: while a user interface corresponding to the application is displayed via the one or more display generation components, receiving, from a system process of the device, an indication that a setting corresponding to the user interface has been changed from a first state to a second state on behalf of the application without the application requesting the setting to be changed, wherein the system process is separate from the application, and wherein the second state is different from the first state; after receiving the indication that the setting corresponding to the user interface has been changed from the first state to the second state on behalf of the application without the application requesting the setting to be changed, detecting, via the one or more input devices, an input corresponding to a request to change the setting; and in response to detecting the input corresponding to the request to change the setting, changing the setting from the second state to a third state different from the second state.

In some embodiments, a transitory computer-readable storage medium storing one or more programs configured to be executed by one or more processors of a device, by an application of the device, that is in communication with one or more display generation components and one or more input devices is described. In some embodiments, the one or more programs includes instructions for: while a user interface corresponding to the application is displayed via the one or more display generation components, receiving, from a system process of the device, an indication that a setting corresponding to the user interface has been changed from a first state to a second state on behalf of the application without the application requesting the setting to be changed, wherein the system process is separate from the application, and wherein the second state is different from the first state; after receiving the indication that the setting corresponding to the user interface has been changed from the first state to the second state on behalf of the application without the application requesting the setting to be changed, detecting, via the one or more input devices, an input corresponding to a request to change the setting; and in response to detecting the input corresponding to the request to change the setting, changing the setting from the second state to a third state different from the second state.

In some embodiments, a device, by an application of the device, configured to communicate with one or more display generation components and one or more input devices is described. In some embodiments, the device comprises one or more processors and memory storing one or more programs configured to be executed by the one or more processors. In some embodiments, the one or more programs includes instructions for: while a user interface corresponding to the application is displayed via the one or more display generation components, receiving, from a system process of the device, an indication that a setting corresponding to the user interface has been changed from a first state to a second state on behalf of the application without the application requesting the setting to be changed, wherein the system process is separate from the application, and wherein the second state is different from the first state; after receiving the indication that the setting corresponding to the user interface has been changed from the first state to the second state on behalf of the application without the application requesting the setting to be changed, detecting, via the one or more input devices, an input corresponding to a request to change the setting; and in response to detecting the input corresponding to the request to change the setting, changing the setting from the second state to a third state different from the second state.

In some embodiments, a device, by an application of the device, configured to communicate with one or more display generation components and one or more input devices is described. In some embodiments, the device comprises means for performing each of the following steps: while a user interface corresponding to the application is displayed via the one or more display generation components, receiving, from a system process of the device, an indication that a setting corresponding to the user interface has been changed from a first state to a second state on behalf of the application without the application requesting the setting to be changed, wherein the system process is separate from the application, and wherein the second state is different from the first state; after receiving the indication that the setting corresponding to the user interface has been changed from the first state to the second state on behalf of the application without the application requesting the setting to be changed, detecting, via the one or more input devices, an input corresponding to a request to change the setting; and in response to detecting the input corresponding to the request to change the setting, changing the setting from the second state to a third state different from the second state.

In some embodiments, a computer program product is described. In some embodiments, the computer program product comprises one or more programs configured to be executed by one or more processors of a device, by an application of the device, that is in communication with one or more display generation components and one or more input devices. In some embodiments, the one or more programs include instructions for: while a user interface corresponding to the application is displayed via the one or more display generation components, receiving, from a system process of the device, an indication that a setting corresponding to the user interface has been changed from a first state to a second state on behalf of the application without the application requesting the setting to be changed, wherein the system process is separate from the application, and wherein the second state is different from the first state; after receiving the indication that the setting corresponding to the user interface has been changed from the first state to the second state on behalf of the application without the application requesting the setting to be changed, detecting, via the one or more input devices, an input corresponding to a request to change the setting; and in response to detecting the input corresponding to the request to change the setting, changing the setting from the second state to a third state different from the second state.

In some embodiments, a method that is performed at a device, by a system process of the device, that is in communication with one or more display generation components and one or more input devices is described. In some embodiments, the method comprises: while a user interface corresponding to a respective application is displayed via the one or more display generation components, detecting, via the one or more input devices, an input corresponding to a system control; and in response to detecting the input corresponding to the system control: changing a setting corresponding to the user interface from a first state to a second state different from the first state; in accordance with a determination that the respective application is a first application, causing the first application to be notified of the input corresponding to the system control; and in accordance with a determination that the respective application is a second application, causing the second application to be notified of the input corresponding to the system control, wherein the second application is different from the first application.

In some embodiments, a non-transitory computer-readable storage medium storing one or more programs configured to be executed by one or more processors of a device, by a system process of the device, that is in communication with one or more display generation components and one or more input devices is described. In some embodiments, the one or more programs includes instructions for: while a user interface corresponding to a respective application is displayed via the one or more display generation components, detecting, via the one or more input devices, an input corresponding to a system control; and in response to detecting the input corresponding to the system control: changing a setting corresponding to the user interface from a first state to a second state different from the first state; in accordance with a determination that the respective application is a first application, causing the first application to be notified of the input corresponding to the system control; and in accordance with a determination that the respective application is a second application, causing the second application to be notified of the input corresponding to the system control, wherein the second application is different from the first application.

In some embodiments, a transitory computer-readable storage medium storing one or more programs configured to be executed by one or more processors of a device, by a system process of the device, that is in communication with one or more display generation components and one or more input devices is described. In some embodiments, the one or more programs includes instructions for: while a user interface corresponding to a respective application is displayed via the one or more display generation components, detecting, via the one or more input devices, an input corresponding to a system control; and in response to detecting the input corresponding to the system control: changing a setting corresponding to the user interface from a first state to a second state different from the first state; in accordance with a determination that the respective application is a first application, causing the first application to be notified of the input corresponding to the system control; and in accordance with a determination that the respective application is a second application, causing the second application to be notified of the input corresponding to the system control, wherein the second application is different from the first application.

In some embodiments, a device, by a system process of the device, configured to communicate with one or more display generation components and one or more input devices is described. In some embodiments, the device comprises one or more processors and memory storing one or more programs configured to be executed by the one or more processors. In some embodiments, the one or more programs includes instructions for: while a user interface corresponding to a respective application is displayed via the one or more display generation components, detecting, via the one or more input devices, an input corresponding to a system control; and in response to detecting the input corresponding to the system control: changing a setting corresponding to the user interface from a first state to a second state different from the first state; in accordance with a determination that the respective application is a first application, causing the first application to be notified of the input corresponding to the system control; and in accordance with a determination that the respective application is a second application, causing the second application to be notified of the input corresponding to the system control, wherein the second application is different from the first application.

In some embodiments, a device, by a system process of the device, configured to communicate with one or more display generation components and one or more input devices is described. In some embodiments, the device comprises means for performing each of the following steps: while a user interface corresponding to a respective application is displayed via the one or more display generation components, detecting, via the one or more input devices, an input corresponding to a system control; and in response to detecting the input corresponding to the system control: changing a setting corresponding to the user interface from a first state to a second state different from the first state; in accordance with a determination that the respective application is a first application, causing the first application to be notified of the input corresponding to the system control; and in accordance with a determination that the respective application is a second application, causing the second application to be notified of the input corresponding to the system control, wherein the second application is different from the first application.

In some embodiments, a computer program product is described. In some embodiments, the computer program product comprises one or more programs configured to be executed by one or more processors of a device, by a system process of the device, that is in communication with one or more display generation components and one or more input devices. In some embodiments, the one or more programs include instructions for: while a user interface corresponding to a respective application is displayed via the one or more display generation components, detecting, via the one or more input devices, an input corresponding to a system control; and in response to detecting the input corresponding to the system control: changing a setting corresponding to the user interface from a first state to a second state different from the first state; in accordance with a determination that the respective application is a first application, causing the first application to be notified of the input corresponding to the system control; and in accordance with a determination that the respective application is a second application, causing the second application to be notified of the input corresponding to the system control, wherein the second application is different from the first application.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a compute system in accordance with some embodiments.

FIGS. 1B-1G illustrate the use of Application Programming Interfaces (APIs) to perform operations in accordance with some embodiments.

FIG. 2 is a block diagram illustrating a device with interconnected subsystems in accordance with some embodiments.

FIGS. 3A-3B illustrate exemplary user interfaces for responding to inputs in accordance with some embodiments.

FIG. 4 is a flow diagram illustrating a process for separately notifying different processes in accordance with some embodiments.

FIG. 5 is a flow diagram illustrating a process for passing through requests in accordance with some embodiments.

FIG. 6 is a flow diagram illustrating a process for out-of-band changes in accordance with some embodiments.

FIG. 7 is a flow diagram illustrating a process for updating settings in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

Processes described herein can include one or more steps that are contingent upon one or more conditions being satisfied. It should be understood that a process can occur over multiple iterations of the same process with different steps of the process being satisfied in different iterations. For example, if a process requires performing a first step upon a determination that a set of one or more criteria is met and a second step upon a determination that the set of one or more criteria is not met, a person of ordinary skill in the art would appreciate that the steps of the process are repeated until both conditions, in no particular order, are satisfied. Thus, a process described with steps that are contingent upon a condition being satisfied can be rewritten as a process that is repeated until each of the conditions described in the process are satisfied. This, however, is not required of system or computer readable medium claims where the system or computer readable medium claims include instructions for performing one or more steps that are contingent upon one or more conditions being satisfied. Because the instructions for the system or computer readable medium claims are stored in one or more processors and/or at one or more memory locations, the system or computer readable medium claims include logic that can determine whether the one or more conditions have been satisfied without explicitly repeating steps of a process until all of the conditions upon which steps in the process are contingent have been satisfied. A person having ordinary skill in the art would also understand that, similar to a process with contingent steps, a system or computer readable storage medium can repeat the steps of a process as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first subsystem could be termed a second subsystem, and, similarly, a second subsystem device or a subsystem device could be termed a first subsystem device, without departing from the scope of the various described embodiments. In some embodiments, the first subsystem and the second subsystem are two separate references to the same subsystem. In some embodiments, the first subsystem and the second subsystem are both subsystems, but they are not the same subsystem or the same type of subsystem.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

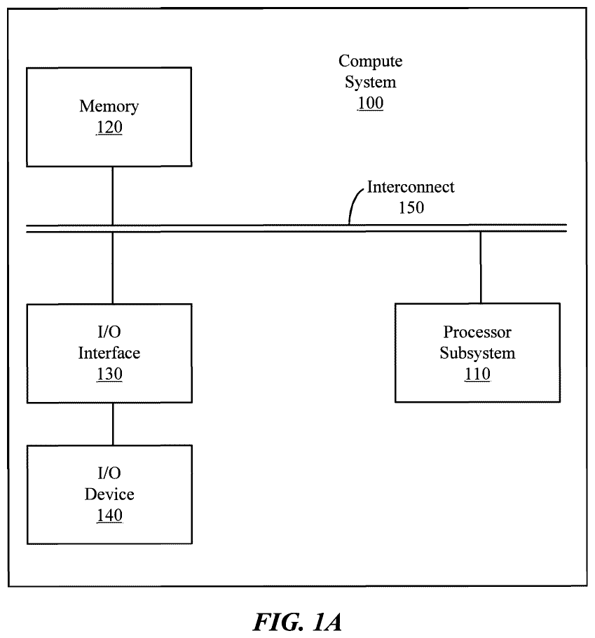

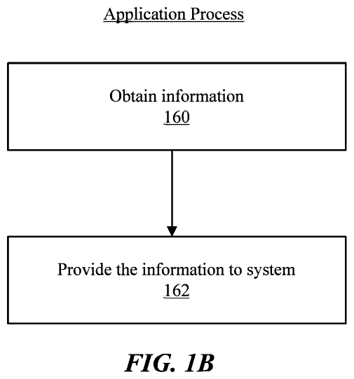

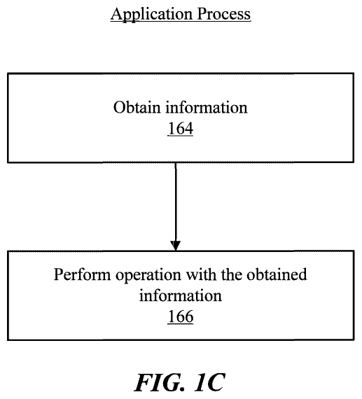

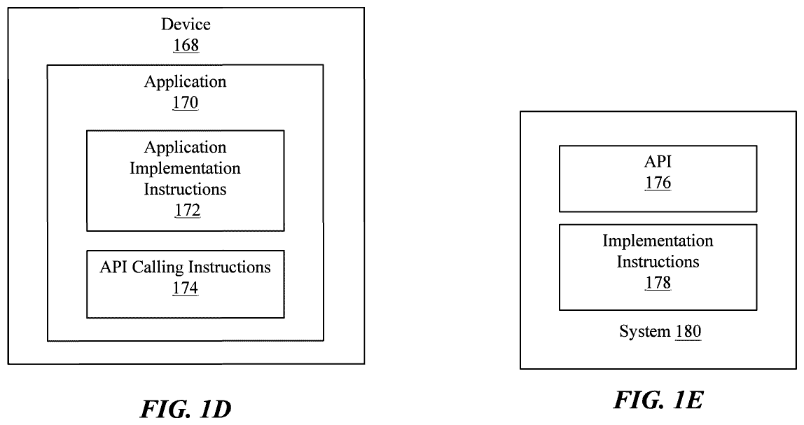

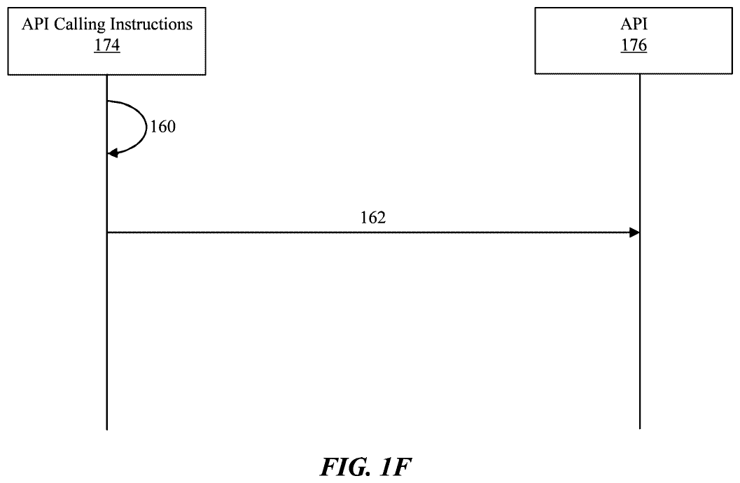

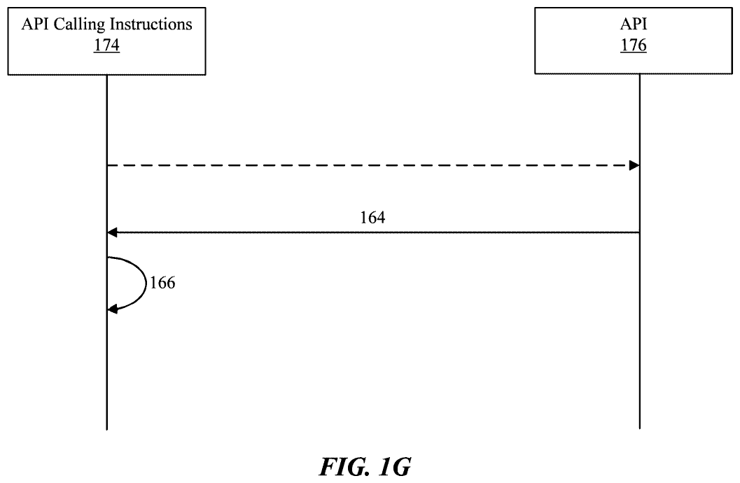

Turning to FIG. 1A, a block diagram of compute system 100 is illustrated. Compute system 100 is a non-limiting example of a compute system that can be used to perform functionality described herein. It should be recognized that other computer architectures of a compute system can be used to perform functionality described herein.

In the illustrated example, compute system 100 includes processor subsystem 110 communicating with (e.g., wired or wirelessly) memory 120 (e.g., a system memory) and I/O interface 130 via interconnect 150 (e.g., a system bus, one or more memory locations, or other communication channel for connecting multiple components of compute system 100). In addition, I/O interface 130 is communicating with (e.g., wired or wirelessly) to I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Compute system 100 can be any of various types of devices, including, but not limited to, a system on a chip, a server system, a personal computer system (e.g., a smartphone, a smartwatch, a wearable device, a tablet, a laptop computer, and/or a desktop computer), a sensor, or the like. In some embodiments, compute system 100 is included or communicating with a physical component for the purpose of modifying the physical component in response to an instruction. In some embodiments, compute system 100 receives an instruction to modify a physical component and, in response to the instruction, causes the physical component to be modified. In some embodiments, the physical component is modified via an actuator, an electric signal, and/or algorithm. Examples of such physical components include an acceleration control, a break, a gear box, a hinge, a motor, a pump, a refrigeration system, a spring, a suspension system, a steering control, a pump, a vacuum system, and/or a valve. In some embodiments, a sensor includes one or more hardware components that detect information about a physical environment in proximity to (e.g., surrounding) the sensor. In some embodiments, a hardware component of a sensor includes a sensing component (e.g., an image sensor or temperature sensor), a transmitting component (e.g., a laser or radio transmitter), a receiving component (e.g., a laser or radio receiver), or any combination thereof. Examples of sensors include an angle sensor, a chemical sensor, a brake pressure sensor, a contact sensor, a non-contact sensor, an electrical sensor, a flow sensor, a force sensor, a gas sensor, a humidity sensor, an image sensor (e.g., a camera sensor, a radar sensor, and/or a LiDAR sensor), an inertial measurement unit, a leak sensor, a level sensor, a light detection and ranging system, a metal sensor, a motion sensor, a particle sensor, a photoelectric sensor, a position sensor (e.g., a global positioning system), a precipitation sensor, a pressure sensor, a proximity sensor, a radio detection and ranging system, a radiation sensor, a speed sensor (e.g., measures the speed of an object), a temperature sensor, a time-of-flight sensor, a torque sensor, and an ultrasonic sensor. In some embodiments, a sensor includes a combination of multiple sensors. In some embodiments, sensor data is captured by fusing data from one sensor with data from one or more other sensors. Although a single compute system is shown in FIG. 1A, compute system 100 can also be implemented as two or more compute systems operating together.

In some embodiments, processor subsystem 110 includes one or more processors or processing units configured to execute program instructions to perform functionality described herein. For example, processor subsystem 110 can execute an operating system, a middleware system, one or more applications, or any combination thereof.

In some embodiments, the operating system manages resources of compute system 100. Examples of types of operating systems covered herein include batch operating systems (e.g., Multiple Virtual Storage (MVS)), time-sharing operating systems (e.g., Unix), distributed operating systems (e.g., Advanced Interactive eXecutive (AIX), network operating systems (e.g., Microsoft Windows Server), and real-time operating systems (e.g., QNX). In some embodiments, the operating system includes various procedures, sets of instructions, software components, and/or drivers for controlling and managing general system tasks (e.g., memory management, storage device control, power management, or the like) and for facilitating communication between various hardware and software components. In some embodiments, the operating system uses a priority-based scheduler that assigns a priority to different tasks that processor subsystem 110 can execute. In such examples, the priority assigned to a task is used to identify a next task to execute. In some embodiments, the priority-based scheduler identifies a next task to execute when a previous task finishes executing. In some embodiments, the highest priority task runs to completion unless another higher priority task is made ready.

In some embodiments, the middleware system provides one or more services and/or capabilities to applications (e.g., the one or more applications running on processor subsystem 110) outside of what the operating system offers (e.g., data management, application services, messaging, authentication, API management, or the like). In some embodiments, the middleware system is designed for a heterogeneous computer cluster to provide hardware abstraction, low-level device control, implementation of commonly used functionality, message-passing between processes, package management, or any combination thereof. Examples of middleware systems include Lightweight Communications and Marshalling (LCM), PX4, Robot Operating System (ROS), and ZeroMQ. In some embodiments, the middleware system represents processes and/or operations using a graph architecture, where processing takes place in nodes that can receive, post, and multiplex sensor data messages, control messages, state messages, planning messages, actuator messages, and other messages. In such examples, the graph architecture can define an application (e.g., an application executing on processor subsystem 110 as described above) such that different operations of the application are included with different nodes in the graph architecture.

In some embodiments, a message sent from a first node in a graph architecture to a second node in the graph architecture is performed using a publish-subscribe model, where the first node publishes data on a channel in which the second node can subscribe. In such examples, the first node can store data in memory (e.g., memory 120 or some local memory of processor subsystem 110) and notify the second node that the data has been stored in the memory. In some embodiments, the first node notifies the second node that the data has been stored in the memory by sending a pointer (e.g., a memory pointer, such as an identification of a memory location) to the second node so that the second node can access the data from where the first node stored the data. In some embodiments, the first node would send the data directly to the second node so that the second node would not need to access a memory based on data received from the first node.

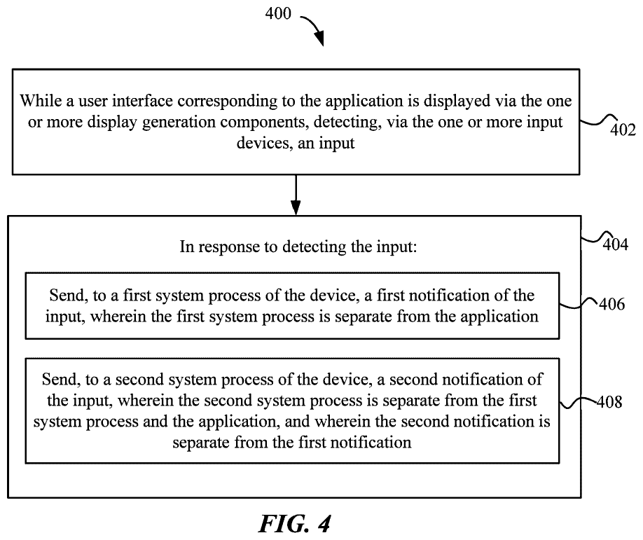

Memory 120 can include a computer readable medium (e.g., non-transitory or transitory computer readable medium) usable to store (e.g., configured to store, assigned to store, and/or that stores) program instructions executable by processor subsystem 110 to cause compute system 100 to perform various operations described herein. For example, memory 120 can store program instructions to implement the functionality associated with processes 400, 500, 600, and 700 (FIGS. 4, 5, 6, and 7) described below.

Memory 120 can be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, or the like), read only memory (PROM, EEPROM, or the like), or the like. Memory in compute system 100 is not limited to primary storage such as memory 120. Compute system 100 can also include other forms of storage such as cache memory in processor subsystem 110 and secondary storage on I/O device 140 (e.g., a hard drive, storage array, etc.). In some embodiments, these other forms of storage can also store program instructions executable by processor subsystem 110 to perform operations described herein. In some embodiments, processor subsystem 110 (or each processor within processor subsystem 110) contains a cache or other form of on-board memory.

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (hard drive, optical drive, removable flash drive, storage array, SAN, or their associated controller), network interface devices (e.g., to a local or wide-area network), sensor devices (e.g., camera, radar, LiDAR, ultrasonic sensor, GPS, inertial measurement device, or the like), and auditory or visual output devices (e.g., speaker, light, screen, projector, or the like). In some embodiments, compute system 100 is communicating with a network via a network interface device (e.g., configured to communicate over Wi-Fi, Bluetooth, Ethernet, or the like). In some embodiments, compute system 100 is directly or wired to the network.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, software modules, and/or components.

Implementations within the scope of the present disclosure include a computer-readable storage medium that encodes instructions organized as an application (e.g., application 170) that, when executed by one or more processing units, control an electronic device (e.g., device 168) to perform the process of FIG. 1B, the process of FIG. 1C, and/or one or more other processes and/or processes described herein.

It should be recognized that application 170 (e.g., illustrated in FIG. 1D) can be any suitable type of application, including, for example, one or more of: a browser application, an application that functions as an execution environment for plug-ins, widgets, or other applications, a fitness application, a health application, an accessory management application, a home application, a digital payments application, a media application, a social network application, a messaging application, and/or a maps application. In some embodiments, application 170 is an application that is pre-installed on device 168 at purchase (e.g., a first party application). In some embodiments, application 170 is an application that is provided to device 168 via an operating system update file (e.g., a first party application or a second party application). In other embodiments, application 170 is an application that is provided via an application store. In some embodiments, the application store can be an application store that is pre-installed on device 168 at purchase (e.g., a first party application store). In some embodiments, the application store is a third-party application store (e.g., an application store that is provided by another application store, downloaded via a network, and/or read from a storage device).

Referring to FIG. 1B and FIG. 1F, application 170 obtains information (e.g., 160). In some embodiments, at 160, information is obtained from at least one hardware component of device 168. In some embodiments, at 160, information is obtained from at least one software module (e.g., a set of one more instructions) of device 168. In some embodiments, at 160, information is obtained from at least one hardware component external to device 168 (e.g., a peripheral device, an accessory device, and/or a server). In some embodiments, the information obtained at 160 includes positional information, time information, notification information, user information, environment information, electronic device state information, weather information, media information, historical information, event information, hardware information, and/or motion information. In some embodiments, in response to and/or after obtaining the information at 160, application 170 provides the information to operating system (e.g., 162).

In some embodiments, the system (e.g., 180 as illustrated in FIG. 1E) is an operating system hosted on device 168. In some embodiments, the system (e.g., 180 as illustrated in FIG. 1E) is an external device (e.g., a server, a peripheral device, an accessory, and/or a personal computing device) that includes an operating system.

Referring to FIG. 1C, application 170 obtains information (e.g., 164). In some embodiments, the information obtained at 164 includes positional information, time information, notification information, user information, environment information electronic device state information, weather information, media information, historical information, event information, hardware information and/or motion information. In response to and/or after obtaining the information at 164, application 170 performs an operation with the information (e.g., 166). In some embodiments, the operation performed at 166 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 180 based on the information.

In some embodiments, one or more steps of the process of FIG. 1B and/or the process of FIG. 1C is performed in response to a trigger. In some embodiments, the trigger includes detection of an event, a notification received from system 180, a user input, and/or a response to a call to an API provided by system 180.

In some embodiments, the instructions of application 170, when executed, control device 168 to perform the process of FIG. 1B and/or the process of FIG. 1C by calling an application programming interface (API) (e.g., API 176) provided by system 180. In some embodiments, application 170 performs at least a portion of the process of FIG. 1B and/or the process of FIG. 1C without calling API 176.

In some embodiments, one or more steps of the process of FIG. 1B and/or the process of FIG. 1C includes calling an API (e.g., API 176) using one or more parameters defined by the API. In some embodiments, the one or more parameters include a constant, a key, a data structure, an object, an object class, a variable, a data type, a pointer, an array, a list or a pointer to a function or a process, and/or another way to reference a data or other item to be passed via the API.

Referring to FIG. 1D, device 168 is illustrated. In some embodiments, device 168 is a personal computing device, a smart phone, a smart watch, a fitness tracker, a head mounted display (HMD) device, a media device, a communal device, a speaker, a television, and/or a tablet. Device 168 includes application 170 and an operating system (not shown) (e.g., system 180 as illustrated in FIG. 1E). Application 170 includes application implementation instructions 172 and API calling instructions 174. System 180 includes API 176 and implementation instructions 178. It should be recognized that device 168, application 170, and/or system 180 can include more, fewer, and/or different components than illustrated in FIGS. 1D and 1E.

In some embodiments, application implementation instructions 172 is a software module that includes a set of one or more computer-readable instructions. In some embodiments, the set of one or more computer-readable instructions correspond to one or more operations performed by application 170. For example, when application 170 is a messaging application, application implementation instructions 172 can include operations to receive and send messages. In some embodiments, application implementation instructions 172 communicates with API calling instructions to communicate with system 180 via API 176 (e.g., as illustrated in FIG. 1E).

In some embodiments, API calling instructions 174 is a software module that includes a set of one or more computer-executable instructions.

In some embodiments, implementation instructions 178 is a software module that includes a set of one or more computer-executable instructions.

In some embodiments, API 176 is a software module that includes a set of one or more computer-executable instructions. In some embodiments, API 176 provides an interface that allows a different set of instructions (e.g., API calling instructions 174) to access and/or use one or more functions, processes, procedures, data structures, classes, and/or other services provided by implementation instructions 178 of system 180. For example, API calling instructions 174 can access a feature of implementation instructions 178 through one or more API calls or invocations (e.g., embodied by a function call, a method call, or a process call) exposed by API 176 and can pass data and/or control information using one or more parameters via the API calls or invocations. In some embodiments, API 176 allows application 170 to use a service provided by a Software Development Kit (SDK) library. In some embodiments, application 170 incorporates a call to a function or process provided by the SDK library and provided by API 176 or uses data types or objects defined in the SDK library and provided by API 176. In some embodiments, API calling instructions 174 makes an API call via API 176 to access and use a feature of implementation instructions 178 that is specified by API 176. In such embodiments, implementation instructions 178 can return a value via API 176 to API calling instructions 174 in response to the API call. The value can report to application 170 the capabilities or state of a hardware component of device 168, including those related to aspects such as input capabilities and state, output capabilities and state, processing capability, power state, storage capacity and state, and/or communications capability. In some embodiments, API 176 is implemented in part by firmware, microcode, or other low level logic that executes in part on the hardware component.

In some embodiments, API 176 allows a developer of API calling instructions 174 (which can be a third-party developer) to leverage a feature provided by implementation instructions 178. In such embodiments, there can be one or more sets of API calling instructions (e.g., including API calling instructions 174) that communicate with implementation instructions 178. In some embodiments, API 176 allows multiple sets of API calling instructions written in different programming languages to communicate with implementation instructions 178 (e.g., API 176 can include features for translating calls and returns between implementation instructions 178 and API calling instructions 174) while API 176 is implemented in terms of a specific programming language. In some embodiments, API calling instructions 174 calls APIs from different providers such as a set of APIs from an OS provider, another set of APIs from a plug-in provider, and/or another set of APIs from another provider (e.g., the provider of a software library) or creator of the another set of APIs.

Examples of API 176 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 168. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 178 is a system (e.g., an operating system and/or a server system) software module (e.g., a collection of computer-readable instructions) that is constructed to perform an operation in response to receiving an API call via API 176. In some embodiments, implementation instructions 178 is constructed to provide an API response (via API 176) as a result of processing an API call. By way of example, implementation instructions 178 and API calling instructions 174 can each be any one of an operating system, a library, a device driver, an API, an application program, or other module. It should be understood that implementation instructions 178 and API calling instructions 174 can be the same or different type of software module from each other. In some embodiments, implementation instructions 178 is embodied at least in part in firmware, microcode, or other hardware logic.

In some embodiments, implementation instructions 178 returns a value through API 176 in response to an API call from API calling instructions 174. While API 176 defines the syntax and result of an API call (e.g., how to invoke the API call and what the API call does), API 176 might not reveal how implementation instructions 178 accomplishes the function specified by the API call. Various API calls are transferred via the one or more application programming interfaces between API calling instructions 174 and implementation instructions 178. Transferring the API calls can include issuing, initiating, invoking, calling, receiving, returning, and/or responding to the function calls or messages. In other words, transferring can describe actions by either of API calling instructions 174 or implementation instructions 178. In some embodiments, a function call or other invocation of API 176 sends and/or receives one or more parameters through a parameter list or other structure.

In some embodiments, implementation instructions 178 provides more than one API, each providing a different view of or with different aspects of functionality implemented by implementation instructions 178. For example, one API of implementation instructions 178 can provide a first set of functions and can be exposed to third party developers, and another API of implementation instructions 178 can be hidden (e.g., not exposed) and provide a subset of the first set of functions and also provide another set of functions, such as testing or debugging functions which are not in the first set of functions. In some embodiments, implementation instructions 178 calls one or more other components via an underlying API and thus be both an API calling instructions and an implementation instructions. It should be recognized that implementation instructions 178 can include additional functions, processes, classes, data structures, and/or other features that are not specified through API 176 and are not available to API calling instructions 174. It should also be recognized that API calling instructions 174 can be on the same system as implementation instructions 178 or can be located remotely and access implementation instructions 178 using API 176 over a network. In some embodiments, implementation instructions 178, API 176, and/or API calling instructions 174 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

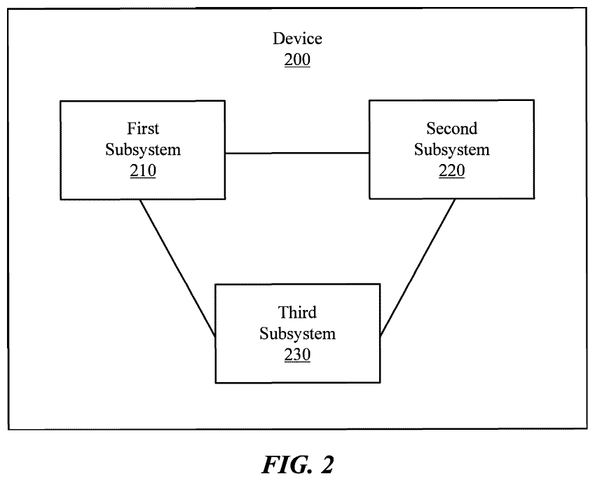

FIG. 2 illustrates a block diagram of device 200 with interconnected subsystems. In the illustrated example, device 200 includes three different subsystems (i.e., first subsystem 210, second subsystem 220, and third subsystem 230) communicating with (e.g., wired or wirelessly) each other, creating a network (e.g., a personal area network, a local area network, a wireless local area network, a metropolitan area network, a wide area network, a storage area network, a virtual private network, an enterprise internal private network, a campus area network, a system area network, and/or a controller area network). An example of a possible computer architecture of a subsystem as included in FIG. 2 is described in FIG. 1A (i.e., compute system 100). Although three subsystems are shown in FIG. 2, device 200 can include more or fewer subsystems.

In some embodiments, some subsystems are not connected to other subsystem (e.g., first subsystem 210 can be connected to second subsystem 220 and third subsystem 230 but second subsystem 220 cannot be connected to third subsystem 230). In some embodiments, some subsystems are connected via one or more wires while other subsystems are wirelessly connected. In some embodiments, messages are set between the first subsystem 210, second subsystem 220, and third subsystem 230, such that when a respective subsystem sends a message the other subsystems receive the message (e.g., via a wire and/or a bus). In some embodiments, one or more subsystems are wirelessly connected to one or more compute systems outside of device 200, such as a server system. In such examples, the subsystem can be configured to communicate wirelessly to the one or more compute systems outside of device 200.

In some embodiments, device 200 includes a housing that fully or partially encloses subsystems 210-230. Examples of device 200 include a home-appliance device (e.g., a refrigerator or an air conditioning system), a robot (e.g., a robotic arm or a robotic vacuum), and a vehicle. In some embodiments, device 200 is configured to navigate (with or without user input) in a physical environment.

In some embodiments, one or more subsystems of device 200 are used to control, manage, and/or receive data from one or more other subsystems of device 200 and/or one or more compute systems remote from device 200. For example, first subsystem 210 and second subsystem 220 can each be a camera that captures images, and third subsystem 230 can use the captured images for decision making. In some embodiments, at least a portion of device 200 functions as a distributed compute system. For example, a task can be split into different portions, where a first portion is executed by first subsystem 210 and a second portion is executed by second subsystem 220.

Attention is now directed towards techniques for responding to inputs. Such techniques are described in the context of system processes on a device. It should be recognized that other types of computer systems can be used with techniques described herein. For example, a computer system including multiple devices (e.g., one device with a client application and another device with a system process control or a hardware daemon) can use techniques described herein. In addition, techniques optionally complement or replace other techniques for responding to inputs.

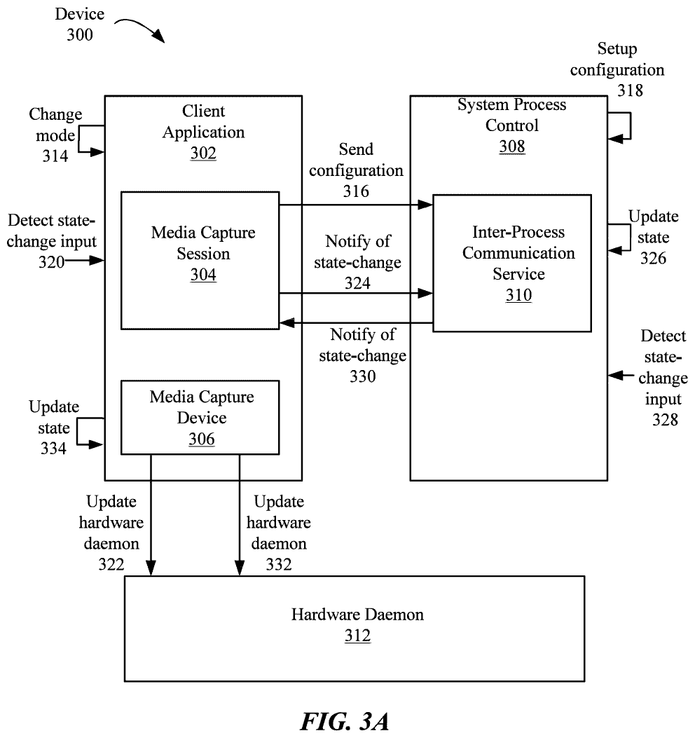

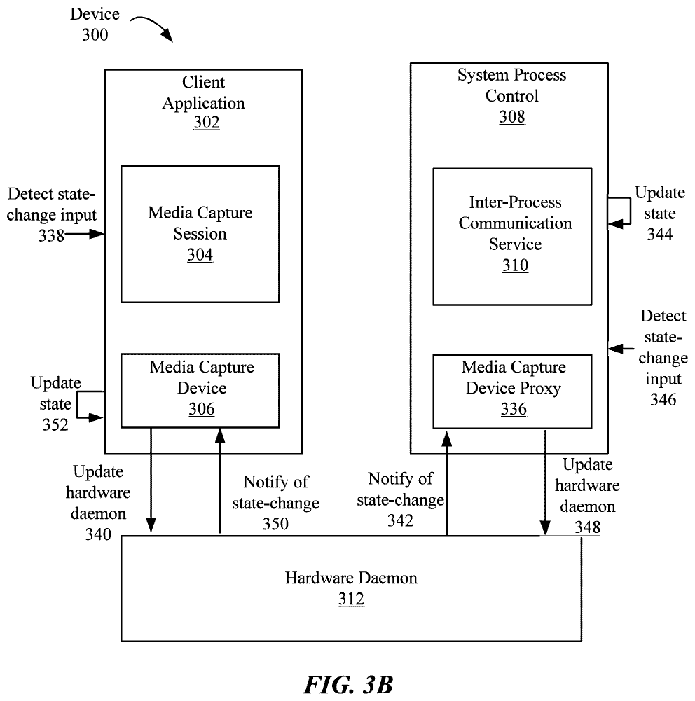

FIGS. 3A-3B illustrate block diagrams of systems for responding to inputs in accordance with some embodiments. The scenarios in these figures are used to illustrate the processes described below, including the processes in FIGS. 4-7.

FIG. 3A is block diagram illustrating a process for setting up communication between different processes of device 300 and how different types of inputs are handled in accordance with some embodiments. Device 300 can be a number of different types of devices, including a smart phone, a smart watch, a fitness tracking device, a laptop, a desktop, a tablet, and/or a television. In some embodiments, device 300 includes and/or is communication with one or more output devices (e.g., a display generation component and/or an audio generation component) and/or one or more input devices (e.g., a touch-sensitive surface, a microphone, and/or a camera). In such embodiments, the one or more input devices can include a system button that is managed by an operating system of device 300. In some embodiments, use of the system button by a client application can require communication between the client application and a system process of the operating system (e.g., the client application cannot use the system button without communication with the system process). An example of the system button can include a mechanical button, capacitive touch button, a touch-sensitive surface, a mechanical slider, and/or a touch slider to detect touch inputs such as a finger on the system button, a press input, a tap input, a press-holds input, and/or a directional swipe input.

As illustrated in FIG. 3A, device 300 includes hardware daemon 312. In some embodiments, hardware daemon 312 is a system process (e.g., software and/or one or more instructions) of the operating system of device 300 and corresponds to a hardware component of device 300, such as an input device of the one or more input devices and/or an output device of the one or more output devices. It should be recognized that hardware daemon 312 does not have to be a system process and can be other types of processes, such as a client process, a user process, and/or an application process.

In some embodiments, hardware daemon 312 is a background process (e.g., software and/or one or more instructions) that manages (1) communication between processes (e.g., different client applications) of device 300 and the hardware component of device 300 and/or (2) one or more settings (e.g., zoom level, exposure, volume, and/or touch sensitivity) of the hardware component of device 300. For example, where the hardware component is a camera, hardware daemon 312 can monitor a status of the camera and facilitate communication and/or control between the hardware component of device 300 and one or more processes of device 300. In some embodiments, communication with and/or from hardware daemon 312 is via an inter-process communication (IPC).

As illustrated in FIG. 3A, device 300 includes client application 302. In some embodiments, client application 302 is an application process (e.g., a background and/or a foreground process, such as software and/or one or more instructions) that operates on device 300 and provides one or more services to device 300 and/or a user of device 300. In some embodiments, client application 302 provides access to the hardware component of device 300 via hardware daemon 312. For example, client application 302 can use an API of hardware daemon 312 to initiate or instantiate an object (e.g., a set of one or more instructions, referred to as media capture device 306 herein), within client application 302 (e.g., outside of hardware daemon 312), for handling communication between client application 302 and hardware daemon 312. In some embodiments, media capture device 306 allows client application 302 to access and/or control the hardware component of device 300. For example, when the hardware component includes a camera, media capture device 306 can facilitate real-time media capture and processing of media captured by the camera. In such an example, client application 302 (e.g., via media capture device 306) can (1) retrieve and/or cause retrieval of media from the camera and (2) manage adjustments to one or more settings corresponding to the camera, such as zoom level, focus, exposure, and/or frame rate. In some embodiments, client application 302 initiates and/or instantiates media capture device 306 when client application 302 is initiated, when client application 302 displays a user interface that includes a user interface element that, when selected, requires hardware daemon 312, and/or when client application receives a request to access a feature that requires hardware daemon 312. It should be recognized that client application 302 can use other types of APIs (e.g., an API that does not create an object to communicate but rather an API that is used to communicate each individual time) and/or other communication mechanisms for communicating with hardware daemon 312.

As illustrated in FIG. 3A, device 300 includes system process control 308. In some embodiments, system process control 308 is a system process (e.g., a background and/or a foreground process, such as software and/or one or more instructions) of the operating system of device 300 and corresponds to a hardware component of device 300, such as an input device of the one or more input devices and/or an output device of the one or more output devices. It should be recognized that hardware daemon 312 does not have to be a system process and can be other types of processes such as a client process, a user process, and/or an application process. In some embodiments, system process control 308 is separate from hardware daemon 312. In such embodiments, the hardware component corresponding to system process control 308 can be different than the hardware component corresponding to hardware daemon 312. For ease of discussion, the hardware component corresponding to system process control 308 will be referred to as the system button and the hardware component corresponding to hardware daemon 312 will be referred to as the camera.

In some embodiments, system process control 308 monitors a state of the system button and/or whether an input is detected via the system button. When the state changes and/or an input is detected, system process control 308 can notify a client application that is currently active (e.g., running and/or causing display of a user interface that is currently displayed). In some embodiments, communication with and/or from system process control 308 is via an inter-process communication (IPC). In such embodiments, the IPC can be handled by a service of system process control 308, such as inter-process communication service 310. In some embodiments, system process control 308 manages a user interface corresponding to the system button. For example, system process control 308 can display one or more user interface elements (e.g., separate from a user interface of an application) corresponding to the system button when an input is detected via the system button. In such an example, system process control 308 can notify an application that is currently active that the one or more user interface elements are being displayed and/or no longer being displayed.

In some embodiments, system process control 308 provides one or more APIs to applications of device 300 for communicating with system process control 308. For example, client application 302 can use an API of system process control 308 to initiate and/or instantiate an object (e.g., a set of one or more instructions, referred to as media capture session 304 herein) for handling communication between client application 302 and system process control 308 via inter-process communication service 310. In some embodiments, client application 302 initiates and/or instantiates media capture session 304 when client application 302 is initiated, when client application 302 displays a user interface that includes a user interface element that, when selected, requires hardware daemon 312, and/or when client application receives a request to access a feature that requires hardware daemon 312. It should be recognized that client application 302 can use other types of APIs (e.g., an API that does not create an object to communicate but rather an API that is used to communicate each individual time) and/or other communication mechanisms for communicating with hardware daemon 312.

At FIG. 3A, client application 302 is configured to (1) display one or more user interfaces, (2) receive captured media for a user interface of client application 302 from the camera (e.g., via hardware daemon 312 and/or another system process), and/or (3) modify one or more settings corresponding to the user interface via client application 302 and/or hardware daemon 312. For example, client application 302 can be a camera application that enables a user to capture images via the camera. In such an example, client application 302 can modify settings of the camera by sending requests to hardware daemon 312 and/or apply different filters to media received from the camera by performing operations without communicating with hardware daemon 312.

At 314, client application 302 changes modes from a first mode (e.g., a mode that does not require content from the camera) to a second mode (e.g., a mode that requires content from the camera). For example, client application 302 can detect an input that causes client application 302 to change display from one user interface of client application 302 to another user interface of client application 302 (e.g., the other user interface requiring content captured via the camera).

In response to changing to the second mode, client application 302 initiates and/or instantiates media capture session 304 using the API described above. As part of initiating and/or instantiating media capture session 304, client application 302 can prepare a configuration for media capture session 304, such as by defining one or more settings and/or controls that client application 302 wants to be accessible via the system button. For example, client application 302 can configure media capture session 304 to allow system process control 308 to modify a zoom level of the camera on behalf of client application 302. Other examples of settings and/or controls include exposure of the camera managed by hardware daemon 312 and/or filters managed by client application 302. In some embodiments, configuring media capture session 304 includes defining a range that system process control 308 can modify the one or more settings and/or controls on behalf of client application 302 (e.g., the range can be less than a range allowed by client application 302). In other embodiments, the range is defined by system process control 308 and is determined via communication between system process control 308 and hardware daemon 312).

At 316, after initiating media capture session 304, client application 302 (e.g., via media capture session 304) sends the configuration to system process control 308 using inter-process communication service 310. In some embodiments, the configuration provides permission to system process control 308 to request changes and/or to change settings corresponding to the user interface of client application 302 on behalf of client application 302. At 318, system process control 308 takes the configuration provided by client application 302 and configures how client application 302 and system process control 308 will interact with the system button. For example, the configuration can include which settings and/or controls corresponding to the user interface of client application 302 that can be controlled via the system button. In some embodiments, the configuration includes which and/or how one or more user interface elements are displayed by system process control 308.

In some embodiments, client application 302 allows users to control the same settings and/or controls via the user interface of client application 302 and via the system button. For example, client application 302 can display video from the camera while displaying one or more controls for modifying a zoom level of the camera. To use the one or more controls for modifying the zoom level of the camera, client application 302 can request changes to the zoom level via hardware daemon 312 using media capture device 306. In some embodiments, the system button is also configured to be able to modify the zoom level of the camera. In such embodiments, when the zoom level is changed by client application 302 using the one or more controls of client application 302, client application 302 updates system process control 308 and hardware daemon 312 of the change in the zoom level as discussed below with respect to 322 and 324.

At 320, client application 302 detects a state-change input. For example, client application 302 can detect an input corresponding to a user interface element managed by client application 302, such a tap, de-pinch, and/or or swipe gesture to increase a zoom level of the camera.

At 322, in response to detecting the state-change input, client application 302 (e.g., via media capture device 306) sends a request to change the zoom level to hardware daemon 312 via media capture device 306. In response to receiving the request, hardware daemon 312 updates the zoom level of the camera, causing media sent to client application 302 to have the updated zoom level.

At 324, in conjunction with (e.g., before, concurrently, and/or after, such as in response to receiving an indication that the zoom level has been updated) sending the request to change the zoom level, client application 302 notifies system process control 308 of the updated zoom level via media capture session 304 through inter-process communication service 310. In some embodiments, client application 302 (e.g., via media capture session 304) only notifies system process control 308 of certain types of state-change inputs. For example, if system process control 308 is not configured by client application 302 to control an exposure of the camera and the exposure was increased by client application 302, client application 302 (e.g., via media capture session 304) would not notify system process control 308 of the change.

At 326, after being notified of the updated zoom level, system process control 308 updates a local variable of system process control 308 that is keeping track of a current zoom level of the camera, so that system process control 308 can be synchronized with client application 302 and the camera.

As mentioned above, client application 302 can allow system process control 308 to modify certain settings and/or controls via the system button as configured by client application 302. In some embodiments, system process control 308 displays one or more user interface elements such as a menu of different settings that can be modified via the system button, with one of the different settings currently selected. In some embodiments, the different settings can be navigated through and/or individually adjusted using the system button, such as via swipes in different directions. In some embodiments, the one or more user interface elements of system process control 308 can be displayed concurrently with content displayed by client application 302 (e.g., the user interface of client application 302 described above).

At 328, system process control 308 detects a state-change input via the system button. For example, system process control 308 can detect an input corresponding to the system button, such a tap or a swipe gesture to increase a zoom level of the camera. At 330, after determining which application that the input corresponds (e.g., based on which user interface is currently being displayed), system process control 308 sends a request to change the zoom of the camera to client application 302 (e.g., the application that the input corresponds) via inter-process communication service 310 and media capture session 304 as described above.

At 332, client application 302 (e.g., via media capture device 306) sends hardware daemon 312 a request to update the zoom level according to the request received from system process control 308. In response to receiving the request from media capture device 306, hardware daemon 312 changes the zoom level of the camera, causing media sent to client application 302 to have the updated zoom level.

At 334, client application 302 updates a local variable of client application 302 that is keeping track of the current zoom level of the camera (e.g., in response to receiving the request from system process control 308 and/or after receiving confirmation from hardware daemon 312 that the changed has been made). In some embodiments, in conjunction with (e.g., in response to, while, and/or after) updating the local variable of client application 302, client application 302 updates the user interface being displayed by client application 302 to reflect the change in the zoom level.

In some embodiments, in conjunction with (e.g., in response to, while, and/or after) updating the local variable of client application 302, client application 302 notifies (e.g., via media capture device 306) hardware daemon 312 that the zoom level has been updated. In such embodiments, in response to being notified that the zoom level has been updated, system process control 308 updates the local variable of system process control 308 that is keeping track of the current zoom level of the camera, so that system process control 308 can be synchronized with client application 302 and the camera.

While the above described a scenario where configuration of system process control 308 is performed initially, it should be recognized that system process control 308 can be re-configured after being initially configured, such as while the user interface of client application 302 is displayed. For example, while the user interface of client application 302 is displayed, client application 302 (e.g., via media capture session 304) can send a request to system process control 308 to have a different configuration in real time, such as changing which settings and/or controls that can be controlled via the system button and/or changing a range that can be changed via the system button. In response to receiving the request, system process control 308 responds to future inputs based on the different configuration instead of the initial configuration. In some embodiments, after removing permission for system process control 308 to modify a particular setting (e.g., the zoom level as described above), client application 302 will not communicate with system process control 308 (e.g., will not send an indication of a change to the zoom level) when client application 302 detects an input corresponding to a request to change the zoom level and instead only send a request to change the zoom level to hardware daemon 312 via media capture device 306.

FIG. 3B is a block diagram illustrating a different process than FIG. 3A for how different types of inputs are handled in accordance with some embodiments. In FIG. 3B, instead of system process control 308 requesting changes to a zoom level via client application 302 using inter-process communication service 310 and media capture session 304, system process control 308 uses media capture device proxy 336 to directly communicate with hardware daemon 312 to update the zoom level. It should be recognized that the process for setting up communication between different processes of device 300 for FIG. 3B can be the same as described above with respect to FIG. 3A (e.g., description related to 314, 316, and 318), including client application 302 configuring system process control 308.

As illustrated in FIG. 3B, device 300 includes client application 302, system process control 308, and hardware daemon 312. Client application 302, media capture session 304, media capture device 306, hardware daemon 312, and inter-process communication service 310 perform similar functions as described above with respect to FIG. 3A.

As illustrated in FIG. 3B, system process control 308 includes media capture device proxy 336. In some embodiments, media capture device proxy 336 is a software component that acts as an intermediary between system process control 308 and hardware daemon 312. For example, system process control 308 can use an API of hardware daemon 312 to initiate or instantiate an object (e.g., a set of one or more instructions, referred to as media capture device proxy 336 herein), within system process control 308 (e.g., outside of hardware daemon 312), for handling communication between system process control 308 and hardware daemon 312. In some embodiments, media capture device proxy 336 allows system process control 308 to manage adjustments to one or more settings corresponding to the camera, such as zoom level, focus, exposure, and/or frame rate. In some embodiments, system process control 308 initiates and/or instantiates media capture device proxy 336 when system process control 308 is initiated and/or when client application 302 initially communicates with system process control 308 (e.g., configures system process control 308). It should be recognized that system process control 308 can use other types of APIs (e.g., an API that does not create an object to communicate but rather an API that is used to communicate each individual time) and/or other communication mechanisms for communicating with hardware daemon 312. In some embodiments, media capture device proxy 336 can communicate directly to hardware daemon 312 instead of going through client application 302, thereby reducing the number of steps needed for system process control 308 and hardware daemon 312 to communicate.

At FIG. 3B, as described with respect to FIG. 3A, client application 302 allows users to control the camera through a user interface of client application 302. For example, client application 302 can display the user interface that includes video from the camera corresponding to hardware daemon 312 while displaying one or more controls that are managed by client application 302. At 338, client application 302 detects a state-change input. For example, client application 302 can detect an input corresponding to a user interface element managed by client application 302, such a tap, de-pinch, or swipe gesture to increase a zoom level of the camera.

At 340, in response to detecting the state-change input, client application 302 (e.g., via media capture device 306) sends a request to hardware daemon 312 to update the zoom level of the camera. In response to receiving the request, hardware daemon 312 updates the zoom level of the camera, causing media sent to client application 302 to have the updated zoom level.

At 342, after hardware daemon 312 changes the zoom level of the camera, hardware daemon 312 notifies system process control 308 (e.g., via media capture device proxy 336) of the updated zoom level. At 344, after system process control 308 is notified of the updated zoom level, system process control 308 updates the local variable of system process control 308 that is keeping track of the current zoom level so that system process control 308 is synchronized for the current zoom level with client application 302. It should be recognized that, when system process control 308 is using media capture device proxy 336, client application 302 does not communicate an indication of a change of the zoom level to system process control 308 as described above with respect to FIG. 3A.

At 346, system process control 308 detects a state-change input via the system button. For example, system process control 308 can detect an input corresponding to the system button, such as a tap or swipe gesture to increase a zoom level of the camera. At 348, system process control 308 sends (e.g., via media capture device proxy 336) a request to hardware daemon 312 to have the zoom level changed. In some embodiments, system process control 308 sends the request directly to hardware daemon 312 rather than going through client application 302. In response to receiving the request, hardware daemon 312 changes the zoom level of the camera, causing media sent to client application 302 to have the updated zoom level. At 350, hardware daemon 312 notifies media capture device 306 that the zoom level has been changed. At 352 client application 302 updates the local variable of client application 302. In some embodiments, in conjunction with (e.g., in response to, before, or after) updating the local variable of client application 302, client application 302 updates the user interface of client application 302 to reflect the change. For example, the user interface can be updated with an indication of the updated zoom level of the camera (e.g., in addition to the media changing zoom level).

It should be recognized that, in some embodiments, one or more settings and/or controls are not able to be modified without client application 302 being involved. For example, client application 302 can configure system process control 308 to control which custom filter is used via the system button. In such embodiments, system process control 308 can send a request for a change similar to as described above with respect to 330 and 332. When updating in this manner, hardware daemon 312 and/or client application 302 can notify system process control 308 when the change has been made. In other embodiments, system process control 308 can still send the request to hardware daemon 312, and hardware daemon 312 can communicate with client application 302 to have the change performed.

FIG. 4 is a flow diagram illustrating a process (e.g., process 400) for separately notifying different processes in accordance with some embodiments. Some operations in process 400 are, optionally, combined, the orders of some operations are, optionally, changed, and some operations are, optionally, omitted.

As described below, process 400 provides an intuitive way for separately notifying different processes. Process 400 reduces the cognitive burden on a user, thereby creating a more efficient human-machine interface. For battery-operated computing devices, enabling a user to interact with such devices faster and more efficiently conserves power and increases the time between battery charges.

In some embodiments, process 400 is performed at a device (e.g., 300), by an application (e.g., a camera application, a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) (e.g., 302) of the device, that is in communication with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the device is a watch, a phone, a tablet, a fitness tracking device, a processor, a head-mounted display (HMD) device, a communal device, a media device, a speaker, a television, an electronic device, and/or a personal computing device. In some embodiments, an input device of the one or more input devices is a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface. In some embodiments, the input device is able to detect a mechanical press, a tap, a swipe, a tape and hold, a long hold, a short hold, and/or other touch-based gestures.

While a user interface (e.g., as described above with respect to FIG. 3A) corresponding to the application is displayed via the one or more display generation components, the application detects (402), via the one or more input devices, an input (e.g., a button press, a tap input, and/or a voice input to change a setting (e.g., as described above with respect to FIGS. 3A-3B) associated with and/or corresponding to the user interface). In some embodiments, before detecting the input, the application displays (and/or causes display of) the user interface corresponding to the application. In some embodiments, the user interface corresponding to the application is a user interface of the application. In some embodiments, the user interface corresponding to the application is not a user interface of the application but rather a user interface of another application and/or a system process of the device different from the application of the device. For example, the user interface corresponding to the application can be a camera user interface that is displayed from a user interface of the application for assisting with operation of the application.

In response to (404) detecting the input (and/or while the user interface corresponding to the application is displayed) (e.g., 320), the application sends (406), to a first system process (e.g., a hardware daemon, an input device daemon, an output device daemon, and/or a sensor daemon) (e.g., 312) of the device, a first notification (e.g., a message, a request, an indication, and/or a representation) (e.g., 322) of (and/or corresponding to) the input, wherein the first system process is separate from the application. In some embodiments, the first system process is part of and/or executing on behalf of an operating system of the device. In some embodiments, the first system process facilitates communication between one or more applications of the device and one or more hardware components of the device. In some embodiments, the first notification is sent to the first system process using an API of the first system process, such as an API to create a first object (e.g., 306) to execute in an application process of the application. In some embodiments, the first object sends and/or receives data and/or requests between the application process and the first system process. In some embodiments, the first notification is sent to the first system process using an API of the first system process, such as an API to change a state of a setting (e.g., as described above with respect to FIGS. 3A-3B).

In response to (404) detecting the input, the application sends (408), to a second system process (e.g., an overlay process, a control process, a system control process, a hardware daemon, an input device daemon, an output device daemon, and/or a sensor daemon) (e.g., 308) of the device, a second notification (e.g., a message, a request, an indication, and/or a representation) (e.g., 324) of (and/or corresponding to) the input, wherein the second system process is separate (and/or different) from the first system process and the application, and wherein the second notification is separate (and/or different) from the first notification. In some embodiments, the second system process is part of and/or executing on behalf of the operating system of the device. In some embodiments, the second system process facilitates communication between one or more applications of the device and one or more hardware components of the device. In some embodiments, the second system process manages a system control (e.g., as described above with respect to FIG. 3A) that is able to change one or more settings of the application and/or the device. In some embodiments, the first system process corresponds to a first hardware device (e.g., a camera). In some embodiments, the second system process corresponds to a second hardware device (e.g., a touch-sensitive surface) different and/or separate from the first hardware device. In some embodiments, the second notification is sent to the second system process using an API of the second system process, such as an API to create a second object (e.g., different from the first object) (e.g., 304) to execute in the application process of the application. In some embodiments, the second object sends and/or receives data and/or requests between the application process and the second system process. In some embodiments, the second notification is sent to the second system process using an API of the second system process, such as an API to notify the second system process of one or more changes to a state of a setting (e.g., as described above with respect to FIGS. 3A-3B).

In some embodiments, the first notification of the input includes a request to change a setting (e.g., zoom of a camera, exposure of a camera, a filter used with media captured via a camera, volume of a speaker, and/or brightness of the device) (e.g., as described above with respect to FIGS. 3A-3B) corresponding to (and/or associated with) the user interface. In some embodiments, a state of the setting is managed by the first system process. In some embodiments, the first system process is configured to modify a state of the setting. In some embodiments, the application is not able to modify a state of the setting itself and/or without communicating with the first system process. In some embodiments, in response to detecting the input, the application changes, via the first system process, the setting from a state to another state different from the state.

In some embodiments, the second notification of the input includes an indication of a result (e.g., a requested state, a change as a result, and/or an identification) of the input (e.g., a zoom level for a camera, an exposure level for a camera, a filter to be used with media captured via a camera, a volume level of a speaker, a brightness level of the device, and/or an identification of a state of a setting (e.g., as described above with respect to FIGS. 3A-3B) changed or requested to be changed by the input). In some embodiments, the first system process and not the second system process is configured to modify a setting (e.g., as described above with respect to FIGS. 3A-3B) in response to detecting the input. In some embodiments, in response to detecting the input, the application notifies the second system process that the setting has changed or is being changed from a state to another state different from the state.

In some embodiments, the input corresponds to a request to change a setting (e.g., zoom of a camera, exposure of a camera, a filter used with media captured via a camera, volume of a speaker, and/or brightness of the device) (e.g., as described above with respect to FIGS. 3A-3B) corresponding to (and/or associated with) the user interface. In some embodiments, before detecting the input (and/or while the user interface is being displayed, in response to receiving a request to display the user interface and/or in response to a request to initiate the application), the application sends, to the second system process of the device, permission (e.g., 316) for the second system process to change a state of the setting on behalf of the application. In some embodiments, the setting corresponds to the user interface. In some embodiments, a state of the setting is managed by the first system process. In some embodiments, the first system process is configured to modify a state of the setting. In some embodiments, the application is not able to modify a state of the setting itself and/or without communicating with the first system process. In some embodiments, the second system process is not able to change a state of the setting without receiving the permission for the second system process to change a state of the setting. In some embodiments, the permission for the second system process to change a state of the setting is sent to the second system process using an API of the second system process, such as an API to create a second object (e.g., 304) to execute in the application process of the application. In some embodiments, the second object sends and/or receives data and/or requests between the application process and the second system process. In some embodiments, the permission for the second system process to change a state of the setting is sent to the second system process using an API of the second system process, such as an API to configure the second system process to be able to change a state of the setting.

In some embodiments, after sending the permission for the second system process to change a state of the setting (and/or while the user interface is being displayed), the application receives, from the second system process, a first request (e.g., 330) to change the setting. In some embodiments, the first request to change the setting is sent to the application from the second system process using an API of the second system process, such as an API to create a second object to execute in the application process of the application. In some embodiments, the second object sends and/or receives data and/or requests between the application process and the second system process. In some embodiments, the first request to change the setting is sent to the application from the second system process using an API of the second system process, such as an API to configure the second system process to be able to change a state of the setting. In some embodiments, in response to receiving the request to change the setting (and/or while the user interface is being displayed), the application sends, to the first system process, a second request (e.g., 332) to change the setting (e.g., from a state to another state different from the state) in accordance with the first request to change the setting. In some embodiments, the second request is the first request. In some embodiments, the second request is different from the first request. In some embodiments, in response to receiving the first request to change the setting, the application changes, via the first system process, the setting in accordance with the first request to change the setting. In some embodiments, the second request to change the setting is sent to the first system process using an API of the first system process, such as an API to create a first object (e.g., 306) to execute in an application process of the application. In some embodiments, the first object sends and/or receives data and/or requests between the application process and the first system process. In some embodiments, the second request to change the setting is sent to the first system process using an API of the first system process, such as an API to change a state of a setting (e.g., as described above with respect to FIGS. 3A-3B).

In some embodiments, the input is a first input. In some embodiments, after sending the second request to change the setting (and/or while the user interface is being displayed), the application sends, to the second system process, a request (e.g., as described above with respect to FIG. 3A) to remove permission for the second system process to change a state of the setting. In some embodiments, the request to remove permission for the second system process to change a state of the setting is sent to the second system process using an API of the second system process, such as an API to create a second object (e.g., different from the first object) to execute in the application process of the application. In some embodiments, the second object sends and/or receives data and/or requests between the application process and the second system process. In some embodiments, the request to remove permission for the second system process to change a state of the setting is sent to the second system process using an API of the second system process, such as an API to notify the second system process. In some embodiments, after sending the request to remove permission for the second system process to change a state of the setting (and/or while the user interface is being displayed), the application detects, via the one or more input devices, a second input (e.g., a button press, a tap input, and/or a voice input to change a setting (e.g., as described above with respect to FIGS. 3A-3B) associated with and/or corresponding to the user interface) (e.g., as described above with respect to FIG. 3A). In some embodiments, in response to detecting the second input (and/or while the user interface corresponding to the application is displayed), the application sends, to the first system process of the device, a notification (e.g., a message, a request, an indication, and/or a representation) of (and/or corresponding to) the second input without sending, to the second system process of the device, a notification of (and/or corresponding to) the second input (e.g., as described above with respect to FIG. 3A). In some embodiments, the notification of the second input is sent to the first system process using an API of the first system process, such as an API to create a first object (e.g., 306) to execute in an application process of the application. In some embodiments, the first object sends and/or receives data and/or requests between the application process and the first system process. In some embodiments, the notification of the second input is sent to the first system process using an API of the first system process, such as an API to change a state of a setting (e.g., as described above with respect to FIGS. 3A-3B).

In some embodiments, the permission for the second system process to change a state of the setting is sent in response to detecting a request to display the user interface (e.g., as described above with respect to FIG. 3A). In some embodiments, the permission for the second system process to change a state of the setting is sent in response to detecting initiation of the application.

In some embodiments, the input is a first input. In some embodiments, after detecting the first input (and/or while the user interface is being displayed), the application detects, via the one or more input devices, a third input (e.g., a button press, a tap input, and/or a voice input to change a setting (e.g., as described above with respect to FIGS. 3A-3B) associated with and/or corresponding to the user interface) (e.g., as described above with respect to FIG. 3A), wherein the third input is separate from the first input. In some embodiments, in response to detecting the third input (and/or while the user interface corresponding to the application is displayed), in accordance with a determination that the third input corresponds to a first setting, the application sends, to the first system process of the device, a first notification (e.g., a message, a request, an indication, and/or a representation) of (and/or corresponding to) the third input without sending, to the second system process of the device, a notification of (and/or corresponding to) the input (e.g., as described above with respect to FIG. 3A). In some embodiments, the first notification of the third input is sent to the first system process using an API of the first system process, such as an API to create a first object to execute in an application process of the application. In some embodiments, the first object sends and/or receives data and/or requests between the application process and the first system process. In some embodiments, the third notification of the third input is sent to the first system process using an API of the first system process, such as an API to change a state of a setting (e.g., as described above with respect to FIGS. 3A-3B). In some embodiments, in response to detecting the third input, in accordance with a determination that the third input corresponds to a second setting, the application sends, to the first system process of the device, the first notification (e.g., a message, a request, an indication, and/or a representation) of (and/or corresponding to) the third input, wherein the second setting is different from the first setting (e.g., as described above with respect to FIG. 3A). In some embodiments, the first notification of the third input is sent to the first system process using an API of the first system process, such as an API to create a first object to execute in an application process of the application. In some embodiments, the first object sends and/or receives data and/or requests between the application process and the first system process. In some embodiments, the first notification of the third input is sent to the first system process using an API of the first system process, such as an API to change a state of a setting (e.g., as described above with respect to FIGS. 3A-3B). In some embodiments, in response to detecting the third input, in accordance with the determination that the third input corresponds to the second setting, the application sends, to the second system process of the device, a second notification (e.g., a message, a request, an indication, and/or a representation) of (and/or corresponding to) the third input, and wherein the second notification of the third input is separate (and/or different) from the first notification of the third input (e.g., as described above with respect to FIG. 3A). In some embodiments, the second notification of the third input is sent to the second system process using an API of the second system process, such as an API to create a second object (e.g., different from the first object) to execute in the application process of the application. In some embodiments, the second object sends and/or receives data and/or requests between the application process and the second system process. In some embodiments, the second notification of the third input is sent to the second system process using an API of the second system process, such as an API to notify the second system process of one or more changes to a state of a setting (e.g., as described above with respect to FIGS. 3A-3B).

In some embodiments, the input corresponds to a request to change a zoom level of a camera (e.g., as described above with respect to FIG. 3A). In some embodiments, the one or more input devices includes the camera.

In some embodiments, the input corresponds to a request to change an exposure level of a camera (e.g., as described above with respect to FIG. 3A). In some embodiments, the one or more input devices includes the camera.

In some embodiments, the input corresponds to a request to change a filter (e.g., add a 2D effect, add a 3D effect, add a virtual object, fast forward, slow down, remove color, add color, change color, and/or perform a visual transformation) applied to content (e.g., an image and/or a video) captured via a camera (e.g., as described above with respect to FIG. 3A). In some embodiments, the one or more input devices includes the camera.

In some embodiments, the input corresponds to a request to modify (e.g., move, change an appearance of, or remove) a user interface element of (and/or provided by) the application (e.g., as described above with respect to FIG. 3A). In some embodiments, the user interface element is displayed within the user interface. In some embodiments, the user interface element is provided by the application.

In some embodiments, the input corresponds to a setting (e.g., as described above with respect to FIGS. 3A-3B). In some embodiments, the setting corresponds to the user interface. In some embodiments, while the user interface is being displayed, the application receives, from the second system process, an indication that one or more user interface elements (e.g., a visual representation of the setting and/or a control corresponding to the setting) corresponding to the setting are being displayed (and/or will be displayed) (e.g., as described above with respect to FIG. 3A), wherein the one or more user interface elements are managed by the second system process (e.g., and not the application). In some embodiments, the indication that the one or more user interface elements corresponding to the setting are being displayed is sent to the application from the second system process using an API of the second system process, such as an API to create a second object (e.g., 304) to execute in the application process of the application. In some embodiments, the second object sends and/or receives data and/or requests between the application process and the second system process. In some embodiments, the indication that the one or more user interface elements corresponding to the setting are being displayed is sent to the application from the second system process using an API of the second system process, such as an API to communicate between the second system process and the application. In some embodiments, while the user interface and the one or more user interface elements are being displayed, the application receives, from the second system process, a first request (e.g., 330) to change the setting, wherein the first request to change the setting corresponds to an input (e.g., 328) being detected that corresponds to the one or more user interface elements. In some embodiments, the first request to change the setting is sent to the application from the second system process using an API of the second system process, such as an API to create a second object to execute in the application process of the application. In some embodiments, the second object sends and/or receives data and/or requests between the application process and the second system process. In some embodiments, the first request to change the setting is sent to the application from the second system process using an API of the second system process, such as an API to configure the second system process to be able to change a state of the setting. In some embodiments, in response to detecting the first request to change the setting, the application sends, to the first system process, a second request (e.g., 332) to change the setting (e.g., from a state to another state different from the state) in accordance with the first request to change the setting. In some embodiments, the second request is the first request. In some embodiments, the second request is different from the first request. In some embodiments, in response to receiving the first request to change the setting, the application changes, via the first system process, the setting in accordance with the first request to change the setting. In some embodiments, the second request to change the setting is sent to the first system process using an API of the first system process, such as an API to create a first object (e.g., 306) to execute in an application process of the application. In some embodiments, the first object sends and/or receives data and/or requests between the application process and the first system process. In some embodiments, the second request to change the setting is sent to the first system process using an API of the first system process, such as an API to change a state of a setting (e.g., as described above with respect to FIGS. 3A-3B).

In some embodiments, while the user interface is being displayed and in response to receiving the indication that the one or more user interface elements corresponding to the setting are being displayed (and/or will be displayed), the application changes display of, via the one or more display generation components, the user interface (e.g., as described above with respect to FIG. 3A). In some embodiments, display of the user interface is changed via the first system process. In some embodiments, display of the user interface is changed using an API of the first system process, such as an API to create a first object (e.g., 306) to execute in an application process of the application. In some embodiments, the first object sends and/or receives data and/or requests between the application process and the first system process. In some embodiments, display of the user interface is changed using an API of the first system process, such as an API to change what is being displayed.

In some embodiments, while the user interface is being displayed and after receiving the indication that the one or more user interface elements corresponding to the setting are being displayed (and/or will be displayed), the application receives, from the second system process, an indication that the one or more user interface elements corresponding to the setting are no longer being displayed (and/or will no longer be displayed) (e.g., as described above with respect to FIG. 3A). In some embodiments, the indication that the one or more user interface elements corresponding to the setting are no longer being displayed is sent to the application from the second system process using an API of the second system process, such as an API to create a second object (e.g., 304) to execute in the application process of the application. In some embodiments, the second object sends and/or receives data and/or requests between the application process and the second system process. In some embodiments, the indication that the one or more user interface elements corresponding to the setting are no longer being displayed is sent to the application from the second system process using an API of the second system process, such as an API to communicate between the second system process and the application. In some embodiments, while the user interface is being displayed and in response to receiving the indication that the one or more user interface elements corresponding to the setting are no longer being displayed (and/or will no longer be displayed), the application changes display of, via the one or more display generation components, the user interface. In some embodiments, display of the user interface is changed via the first system process. In some embodiments, display of the user interface is changed using an API of the first system process, such as an API to create a first object to execute in an application process of the application. In some embodiments, the first object sends and/or receives data and/or requests between the application process and the first system process. In some embodiments, display of the user interface is changed using an API of the first system process, such as an API to change what is being displayed.

In some embodiments, in response to detecting the input, the application changes display of, via the one or more display generation components, the user interface (e.g., as described above with respect to FIG. 3A). In some embodiments, display of the user interface is changed via the first system process. In some embodiments, display of the user interface is changed using an API of the first system process, such as an API to create a first object (e.g., 306) to execute in an application process of the application. In some embodiments, the first object sends and/or receives data and/or requests between the application process and the first system process. In some embodiments, display of the user interface is changed using an API of the first system process, such as an API to change what is being displayed.

Note that details of the processes described above with respect to process 400 (e.g., FIG. 4) are also applicable in an analogous manner to other processes described herein. For example, process 500 optionally includes one or more of the characteristics of the various processes described above with reference to process 400. For example, the first process of process 400 can be the second process of process 500. For brevity, these details are not repeated herein.

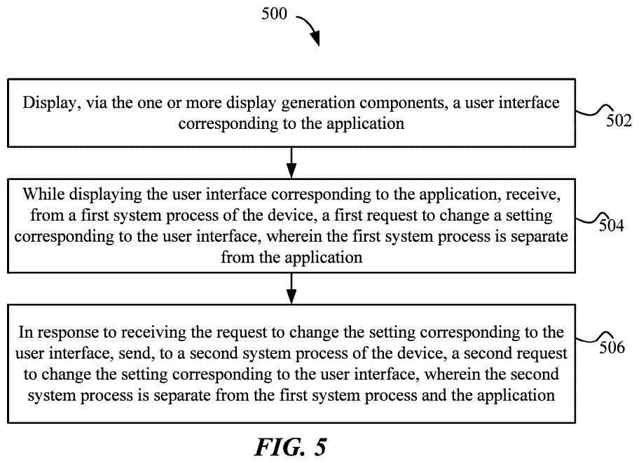

FIG. 5 is a flow diagram illustrating a process (e.g., process 500) for passing through requests in accordance with some embodiments. Some operations in process 500 are, optionally, combined, the orders of some operations are, optionally, changed, and some operations are, optionally, omitted.

As described below, process 500 provides an intuitive way for passing through requests. Process 500 reduces the cognitive burden on a user, thereby creating a more efficient human-machine interface. For battery-operated computing devices, enabling a user to interact with such devices faster and more efficiently conserves power and increases the time between battery charges.

In some embodiments, process 500 is performed at a device (e.g., 300), by an application (e.g., a camera application, a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) (e.g., 302) of the device, that is in communication with (and/or includes) one or more display generation components (e.g., a display screen, a projector, a head mounted display, and/or a touch-sensitive display). In some embodiments, the device is a watch, a phone, a tablet, a fitness tracking device, a processor, a head-mounted display (HMD) device, a communal device, a media device, a speaker, a television, an electronic device, and/or a personal computing device.

The application displays (502), via the one or more display generation components, a user interface (e.g., as described above with respect to FIG. 3A) corresponding to the application. In some embodiments, the user interface corresponding to the application is a user interface of the application. In some embodiments, the user interface corresponding to the application is not a user interface of the application but rather a user interface of another application and/or a system process of the device different from the application of the device. For example, the user interface corresponding to the application can be a camera user interface that is displayed from a user interface of the application for assisting with operation of the application.

While displaying the user interface corresponding to the application, the application receives (504), from a first system process (e.g., an overlay process, a control process, a system control process, a hardware daemon, an input device daemon, an output device daemon, a sensor daemon, and/or the second system process of process 400) (e.g., 308) of the device, a first request (e.g., 330) to change a setting (e.g., as described above with respect to FIGS. 3A-3B) corresponding to the user interface, wherein the first system process is separate from the application. In some embodiments, the first system process is part of and/or executing on behalf of an operating system of the device. In some embodiments, the first system process facilitates communication between one or more applications of the device and one or more hardware components of the device. In some embodiments, the first system process manages a system control that is able to change one or more settings of the application and/or the device. In some embodiments, the first request to change the setting is sent to the application from the first system process using an API of the first system process, such as an API to create a second object (e.g., 304) to execute in the application process of the application. In some embodiments, the second object sends and/or receives data and/or requests between the application process and the first system process. In some embodiments, the first request to change the setting is sent to the application from the first system process using an API of the first system process, such as an API to configure the first system process to be able to change a state of the setting.

In response to receiving the request to change the setting corresponding to the user interface (and/or while displaying the user interface corresponding to the application), the application sends (506), to a second system process (e.g., a hardware daemon, an input device daemon, an output device daemon, and/or a sensor daemon, and/or the first system process of process 400) (e.g., 312) of the device, a second request (e.g., 332) to change the setting corresponding to the user interface, wherein the second system process is separate (and/or different) from the first system process and the application. In some embodiments, the second request is the first request. In some embodiments, the second request is different from the first request. In some embodiments, the second request corresponds to and/or is associated with the first request. In some embodiments, as a result of sending the second request, the application changes display of the user interface. In some embodiments, as a result of sending the second request, display of the user interface changes. For example, a zoom level of a camera can be changed that changes video frames being displayed by the application. In some embodiments, the second system process is part of and/or executing on behalf of the operating system of the device. In some embodiments, the second system process facilitates communication between one or more applications of the device and one or more hardware components of the device. In some embodiments, the first system process corresponds to a first hardware device (e.g., a touch-sensitive surface). In some embodiments, the second system process corresponds to a second hardware device (e.g., a camera) different and/or separate from the first hardware device. In some embodiments, the second request is the first request. In some embodiments, the second request is different from the first request. In some embodiments, in response to receiving the first request to change the setting, the application changes, via the second system process, the setting in accordance with the first request to change the setting. In some embodiments, the second request to change the setting is sent to the second system process using an API of the second system process, such as an API to create a first object (e.g., 306) to execute in an application process of the application. In some embodiments, the first object sends and/or receives data and/or requests between the application process and the second system process. In some embodiments, the second request to change the setting is sent to the second system process using an API of the second system process, such as an API to change a state of a setting (e.g., as described above with respect to FIGS. 3A-3B).

In some embodiments, in response to receiving the request to change the setting corresponding to the user interface (and/or while displaying the user interface corresponding to the application), the application updates (e.g., 334) a local variable storing a current state of the setting. In some embodiments, the local variable is local to the application (e.g., and not local to the first system process or the second system process). In some embodiments, the application uses the local variable to perform one or more operations, such as to display a representation of the current state of the setting using the local variable.

In some embodiments, the device is in communication with (and/or includes) one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, an input device of the one or more input devices is a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface. In some embodiments, the input device is able to detect a mechanical press, a tap, a swipe, a tape and hold, a long hold, a short hold, and/or other touch-based gestures. In some embodiments, while displaying the user interface corresponding to the application, the application detects, via the one or more input devices, an input (e.g., a button press, a tap input, and/or a voice input to change a setting (e.g., as described above with respect to FIGS. 3A-3B) associated with and/or corresponding to the user interface) (e.g., 320). In some embodiments, in response to detecting the input (and/or while the user interface corresponding to the application is displayed), the application sends, to the second system process of the device, a first notification (e.g., a message, a request, an indication, and/or a representation) (e.g., 324) of (and/or corresponding to) the input. In some embodiments, the first notification is sent to the second system process using an API of the second system process, such as an API to create a first object (e.g., 304) to execute in an application process of the application. In some embodiments, the first object sends and/or receives data and/or requests between the application process and the second system process. In some embodiments, the first notification is sent to the second system process using an API of the second system process, such as an API to change a state of a setting (e.g., as described above with respect to FIGS. 3A-3B). In some embodiments, in response to detecting the input, the application sends, to the first system process of the device, a second notification (e.g., a message, a request, an indication, and/or a representation) (e.g., 322) of (and/or corresponding to) the input, wherein the second notification is separate (and/or different) from the first notification. In some embodiments, the second notification is sent to the first system process using an API of the first system process, such as an API to create a second object (e.g., different from the first object) (e.g., 306) to execute in the application process of the application. In some embodiments, the second object sends and/or receives data and/or requests between the application process and the first system process. In some embodiments, the second notification is sent to the first system process using an API of the first system process, such as an API to notify the first system process of one or more changes to a state of a setting (e.g., as described above with respect to FIGS. 3A-3B).

In some embodiments, before receiving the first request to change the setting corresponding to the user interface (and/or while the user interface is being displayed, in response to receiving a request to display the user interface and/or in response to a request to initiate the application), the application sends, to the first system process of the device, permission (e.g., 316) for the first system process to change a state of the setting on behalf of the application. In some embodiments, a state of the setting is managed by the second system process. In some embodiments, the second system process is configured to modify a state of the setting. In some embodiments, the application is not able to modify a state of the setting itself and/or without communicating with the second system process. In some embodiments, the first system process is not able to change a state of the setting without receiving the permission for the first system process to change a state of the setting. In some embodiments, the permission for the first system process to change a state of the setting is sent to the first system process using an API of the first system process, such as an API to create a second object (e.g., 304) to execute in the application process of the application. In some embodiments, the second object sends and/or receives data and/or requests between the application process and the first system process. In some embodiments, the permission for the first system process to change a state of the setting is sent to the first system process using an API of the first system process, such as an API to configure the first system process to be able to change a state of the setting.

In some embodiments, after sending the second request to change the setting (and/or while the user interface is being displayed), the application sends, to the first system process, a request to remove permission for the first system process to change a state of the setting (e.g., as described above with respect to FIG. 3A). In some embodiments, the request to remove permission for the first system process to change a state of the setting is sent to the first system process using an API of the first system process, such as an API to create a second object (e.g., different from the first object) to execute in the application process of the application. In some embodiments, the second object sends and/or receives data and/or requests between the application process and the first system process. In some embodiments, the request to remove permission for the first system process to change a state of the setting is sent to the first system process using an API of the first system process, such as an API to notify the first system process. In some embodiments, after sending the request to remove permission for the first system process to change a state of the setting (and/or while the user interface is being displayed), the application detects, via the one or more input devices, an input (e.g., a button press, a tap input, and/or a voice input to change a setting (e.g., as described above with respect to FIGS. 3A-3B) associated with and/or corresponding to the user interface) (e.g., as described above with respect to FIG. 3A). In some embodiments, in response to detecting the input (and/or while the user interface corresponding to the application is displayed), the application sends, to the second system process of the device, a notification (e.g., a message, a request, an indication, and/or a representation) of (and/or corresponding to) the input without sending, to the first system process of the device, a notification of (and/or corresponding to) the input (e.g., as described above with respect to FIG. 3A). In some embodiments, the notification of the input is sent to the second system process using an API of the second system process, such as an API to create a first object to execute in an application process of the application. In some embodiments, the first object sends and/or receives data and/or requests between the application process and the second system process. In some embodiments, the notification of the input is sent to the second system process using an API of the second system process, such as an API to change a state of a setting (e.g., as described above with respect to FIGS. 3A-3B).

In some embodiments, the permission for the first system process to change a state of the setting on behalf of the application is sent to the first system process in response to detecting a request to display the user interface (e.g., as described above with respect to FIG. 3A). In some embodiments, the permission for the first system process to change a state of the setting on behalf of the application is sent to the first system process in response to detecting initiation of the application.

In some embodiments, the setting is a zoom level of a camera (e.g., as described above with respect to FIG. 3A). In some embodiments, the one or more input devices includes the camera.

In some embodiments, the setting is an exposure level of a camera (e.g., as described above with respect to FIG. 3A). In some embodiments, the one or more input devices includes the camera.

In some embodiments, the setting is a filter (e.g., add a 2D effect, add a 3D effect, add a virtual object, fast forward, slow down, remove color, add color, change color, and/or perform a visual transformation) applied to content (e.g., an image and/or a video) captured via a camera (e.g., as described above with respect to FIG. 3A). In some embodiments, the one or more input devices includes the camera.

In some embodiments, the setting corresponds to a user interface element of (and/or provided by) the application (e.g., as described above with respect to FIG. 3A). In some embodiments, the user interface element is displayed within the user interface. In some embodiments, the user interface element is provided by the application.

In some embodiments, while the user interface is being displayed, the application receives, from the first system process, an indication that one or more user interface elements (e.g., a visual representation of the setting and/or a control corresponding to the setting) corresponding to the setting are being displayed (and/or will be displayed) (e.g., as described above with respect to FIG. 3A), wherein the one or more user interface elements are managed by the first system process (e.g., and not the application). In some embodiments, the indication that the one or more user interface elements corresponding to the setting are being displayed is sent to the application from the first system process using an API of the first system process, such as an API to create a second object to execute in the application process of the application. In some embodiments, the second object sends and/or receives data and/or requests between the application process and the first system process. In some embodiments, the indication that the one or more user interface elements corresponding to the setting are being displayed is sent to the application from the first system process using an API of the first system process, such as an API to communicate between the first system process and the application. In some embodiments, while the user interface and the one or more user interface elements are being displayed, the application receives, from the first system process, a first request (e.g., 330) to change the setting, wherein the first request to change the setting corresponds to an input (e.g., 328) being detected that corresponds to the one or more user interface elements. In some embodiments, the first request to change the setting is sent to the application from the first system process using an API of the first system process, such as an API to create a second object (e.g., 304) to execute in the application process of the application. In some embodiments, the second object sends and/or receives data and/or requests between the application process and the first system process. In some embodiments, the first request to change the setting is sent to the application from the first system process using an API of the first system process, such as an API to configure the first system process to be able to change a state of the setting. In some embodiments, in response to detecting the first request to change the setting, the application sends, to the second system process, a second request (e.g., 332) to change the setting (e.g., from a state to another state different from the state) in accordance with the first request to change the setting. In some embodiments, the second request is the first request. In some embodiments, the second request is different from the first request. In some embodiments, in response to receiving the first request to change the setting, the application changes, via the second system process, the setting in accordance with the first request to change the setting. In some embodiments, the second request to change the setting is sent to the second system process using an API of the second system process, such as an API to create a first object (e.g., 306) to execute in an application process of the application. In some embodiments, the first object sends and/or receives data and/or requests between the application process and the second system process. In some embodiments, the second request to change the setting is sent to the second system process using an API of the second system process, such as an API to change a state of a setting (e.g., as described above with respect to FIGS. 3A-3B).

In some embodiments, while the user interface is being displayed and in response to receiving the indication that the one or more user interface elements corresponding to the setting are being displayed (and/or will be displayed), the application changes display of, via the one or more display generation components, the user interface (e.g., as described above with respect to FIG. 3A). In some embodiments, display of the user interface is changed via the second system process. In some embodiments, display of the user interface is changed using an API of the second system process, such as an API to create a first object (e.g., 306) to execute in an application process of the application. In some embodiments, the first object sends and/or receives data and/or requests between the application process and the second system process. In some embodiments, display of the user interface is changed using an API of the second system process, such as an API to change what is being displayed.

In some embodiments, in response to receiving the first request to change the setting corresponding to the user interface (and/or in response to sending the second request to change the setting corresponding to the user interface), the application changes display of, via the one or more display generation components, the user interface (e.g., as described above with respect to FIG. 3A). In some embodiments, display of the user interface is changed via the second system process. In some embodiments, display of the user interface is changed using an API of the second system process, such as an API to create a first object (e.g., 306) to execute in an application process of the application. In some embodiments, the first object sends and/or receives data and/or requests between the application process and the second system process. In some embodiments, display of the user interface is changed using an API of the second system process, such as an API to change what is being displayed.

Note that details of the processes described above with respect to process 500 (e.g., FIG. 5) are also applicable in an analogous manner to other processes described herein. For example, process 400 optionally includes one or more of the characteristics of the various processes described above with reference to process 500. For example, the first process of process 500 can be the second process of process 400. For brevity, these details are not repeated herein.

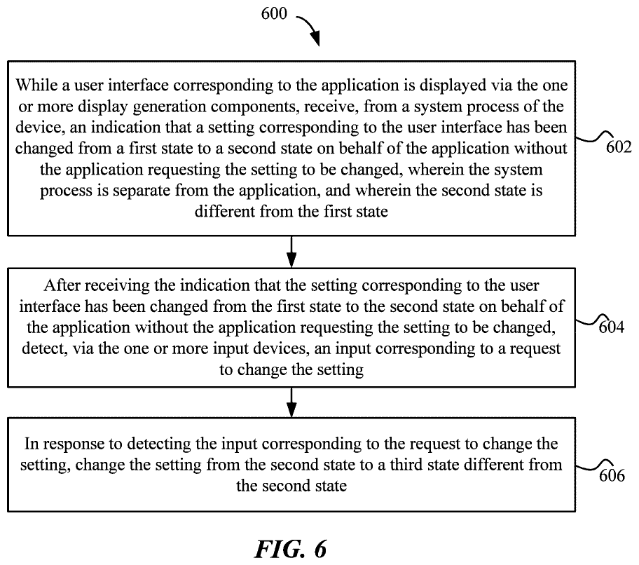

FIG. 6 is a flow diagram illustrating a process (e.g., process 600) for out-of-band changes in accordance with some embodiments. Some operations in process 600 are, optionally, combined, the orders of some operations are, optionally, changed, and some operations are, optionally, omitted.

As described below, process 600 provides an intuitive way for out-of-band changes. Process 600 reduces the cognitive burden on a user, thereby creating a more efficient human-machine interface. For battery-operated computing devices, enabling a user to interact with such devices faster and more efficiently conserves power and increases the time between battery charges.

In some embodiments, process 600 is performed at a device (e.g., 300), by an application (e.g., a camera application, a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) (e.g., 302) of the device, that is in communication with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the device is a watch, a phone, a tablet, a fitness tracking device, a processor, a head-mounted display (HMD) device, a communal device, a media device, a speaker, a television, an electronic device, and/or a personal computing device. In some embodiments, an input device of the one or more input devices is a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface. In some embodiments, the input device is able to detect a mechanical press, a tap, a swipe, a tape and hold, a long hold, a short hold, and/or other touch-based gestures.

While a user interface (e.g., as described above with respect to FIG. 3B) corresponding to the application is displayed via the one or more display generation components, the application receives (602), from a system process (e.g., an overlay process, a control process, a system control process, a hardware daemon, an input device daemon, an output device daemon, a sensor daemon, the first system process of process 400 or process 500, and/or the second system process of process 400 or process 500) (e.g., 308 or 312) of the device, an indication (e.g., 350) that a setting (e.g., as described above with respect to FIGS. 3A-3B) corresponding to (and/or associated with) the user interface has been changed from a first state to a second state on behalf of the application without the application requesting the setting to be changed, wherein the system process is separate from the application, and wherein the second state is different from the first state. In some embodiments, the user interface is being displayed with the setting in the first state before receiving the indication that the setting corresponding to the user interface has been changed from the first state to the second state on behalf of the application without the application requesting the setting to be changed. In some embodiments, the setting is managed by the system process, another system process (e.g., 308 or 312) separate from the system process, the application, and/or another application different from the application. In some embodiments, the setting affects display of the user interface. In some embodiments, before receiving the indication that the setting corresponding to the user interface has been changed from the first state to the second state on behalf of the application without the application requesting the setting to be changed, the application displays (and/or causes display of) the user interface corresponding to the application. In some embodiments, the user interface corresponding to the application is a user interface of the application. In some embodiments, the user interface corresponding to the application is not a user interface of the application but rather a user interface of another application and/or a system process of the device different from the application of the device. For example, the user interface corresponding to the application can be a camera user interface that is displayed from a user interface of the application for assisting with operation of the application. In some embodiments, the system process is part of and/or executing on behalf of an operating system of the device. In some embodiments, the system process facilitates communication between one or more applications of the device and one or more hardware components of the device. In some embodiments, the system process manages a system control that is able to change one or more settings of the application and/or the device. In some embodiments, the system process corresponds to a hardware device (e.g., a touch-sensitive surface and/or a camera). In some embodiments, the indication that the setting corresponding to the user interface has been changed is sent to the application from the system process using an API of the system process, such as an API to create a second object (e.g., 306) to execute in the application process of the application. In some embodiments, the second object sends and/or receives data and/or requests between the application process and the system process. In some embodiments, the indication that the setting corresponding to the user interface has been changed is sent to the application from the system process using an API of the system process, such as an API to notify the application of changes to the setting.

After receiving the indication that the setting corresponding to the user interface has been changed from the first state to the second state on behalf of the application without the application requesting the setting to be changed (and/or while the user interface corresponding to the application is displayed), the application detects (604), via the one or more input devices, an input (e.g., a button press, a tap input, and/or a voice input) (e.g., 338) corresponding to a request to change the setting.

In response to detecting the input corresponding to the request to change the setting (and/or while the user interface corresponding to the application is displayed), the application changes (606) (e.g., via the system process and/or another system process different from the system process) (e.g., 340) the setting from the second state to a third state different from the second state. In some embodiments, the third state is the first state. In some embodiments, the third state is different from the first state.

In some embodiments, in response to receiving the indication that the setting corresponding to the user interface has been changed from the first state to the second state on behalf of the application without the application requesting the setting to be changed (and/or while the user interface corresponding to the application is displayed), the application updates (e.g., 352) a local variable storing a current state of the setting. In some embodiments, the local variable is local to the application (e.g., and not local to the system process or another system process (e.g., the first system process or the second system process as described above with respect to process 400, process 500, and/or process 600)). In some embodiments, the application uses the local variable to perform one or more operations, such as to display a representation of the current state of the setting using the local variable.

In some embodiments, the system process is a first system process. In some embodiments, before receiving the indication that the setting corresponding to the user interface has been changed from the first state to the second state on behalf of the application without the application requesting the setting to be changed (and/or while the user interface corresponding to the application is displayed or not displayed), the application sends, to a second system process (e.g., the first system process or another system process different from the first system process) (e.g., 308 or 312), permission (e.g., 316) for the second system process (or the first system process) to change a state of the setting on behalf of the application. In some embodiments, a state of the setting is managed by the first system process. In some embodiments, the second system process is configured to modify a state of the setting. In some embodiments, the application is not able to modify a state of the setting itself and/or without communicating with the first system process. In some embodiments, the second system process is not able to change a state of the setting without receiving the permission for the second system process to change a state of the setting. In some embodiments, the permission for the second system process to change a state of the setting is sent to the second system process using an API of the second system process, such as an API to create a second object (e.g., 304) to execute in the application process of the application. In some embodiments, the second object sends and/or receives data and/or requests between the application process and the second system process. In some embodiments, the permission for the second system process to change a state of the setting is sent to the second system process using an API of the second system process, such as an API to configure the second system process to be able to change a state of the setting.

In some embodiments, after receiving the indication that the setting corresponding to the user interface has been changed from the first state to the second state on behalf of the application without the application requesting the setting to be changed (and/or while the user interface corresponding to the application is displayed), the application sends, to the second system process (or the first system process), a request to remove permission for the second system process (or the first system process) to change a state of the setting (e.g., as described above with respect to FIG. 3B). In some embodiments, the request to remove permission for the second system process (or the first system process) to change a state of the setting is sent to the second system process (or the first system process) using an API of the second system process (or the first system process), such as an API to create a second object (e.g., different from the first object) to execute in the application process of the application. In some embodiments, the second object sends and/or receives data and/or requests between the application process and the first system process (or the first system process). In some embodiments, the request to remove permission for the second system process (or the first system process) to change a state of the setting is sent to the second system process (or the first system process) using an API of the second system process (or the first system process), such as an API to notify the second system process (or the first system process).

In some embodiments, the permission for the second system process (or the first system process) to change a state of the setting on behalf of the application is sent in response to detecting a request to display the user interface (e.g., as described above with respect to FIG. 3B). In some embodiments, the permission for the second system process (or the first system process) to change a state of the setting on behalf of the application is sent in response to detecting initiation of the application.

In some embodiments, the system process is a first system process. In some embodiments, the setting is changed from the second state to the third state via a second system process (e.g., a hardware daemon, an input device daemon, an output device daemon, and/or a sensor daemon) (e.g., 312) of the device, different from the first system process of the device, and not via the first system process (e.g., 318).

In some embodiments, the setting is changed from the second state to the third state via the system process (e.g., 312).

In some embodiments, the system process is a first system process. In some embodiments, the setting is a first setting. In some embodiments, while the user interface corresponding to the application is displayed, the application receives, from a second system process (e.g., an overlay process, a control process, a system control process, a hardware daemon, an input device daemon, an output device daemon, a sensor daemon, the first system process of process 400, process 500, or process 600, and/or the second system process of process 400, process 500, or process 600) of the device, a request to change a second setting different from the first setting (e.g., as described above with respect to FIG. 3B). In some embodiments, the second system process is the first system process. In some embodiments, the second system process is different from the first system process. In some embodiments, the request to change the second setting is sent to the application from the second system process using an API of the second system process, such as an API to create a second object to execute in the application process of the application. In some embodiments, the second object sends and/or receives data and/or requests between the application process and the second system process. In some embodiments, the request to change the second setting is sent to the application from the second system process using an API of the second system process, such as an API to configure the second system process to be able to change a state of the second setting. In some embodiments, in response to receiving the request to change the second setting (and/or while displaying the user interface corresponding to the application), the application changes (e.g., via the application, the first system process, and/or the second system process) the second setting in accordance with the request to change the second setting (e.g., as described above with respect to FIG. 3B).

In some embodiments, the setting is a zoom level of a camera (e.g., as described above with respect to FIG. 3B). In some embodiments, the one or more input devices includes the camera.

In some embodiments, the setting is an exposure level of a camera (e.g., as described above with respect to FIG. 3B). In some embodiments, the one or more input devices includes the camera.

In some embodiments, the setting is a filter (e.g., add a 2D effect, add a 3D effect, add a virtual object, fast forward, slow down, remove color, add color, change color, and/or perform a visual transformation) applied to content (e.g., an image and/or a video) captured via a camera (e.g., as described above with respect to FIG. 3B). In some embodiments, the one or more input devices includes the camera.

In some embodiments, the setting corresponds to a user interface element of (and/or provided by) the application (e.g., as described above with respect to FIG. 3B). In some embodiments, the user interface element is displayed within the user interface. In some embodiments, the user interface element is provided by the application.

In some embodiments, the system process is a first system process. In some embodiments, while the user interface is being displayed, the application receives, from a second system process (e.g., the first system process or another system process different from the first system process), an indication that one or more user interface elements (e.g., a visual representation of the setting and/or a control corresponding to the setting) corresponding to the setting are being displayed (and/or will be displayed) (e.g., as described above with respect to FIG. 3B), wherein the one or more user interface elements are managed by the second system process (or the first system process) (e.g., and not the application). In some embodiments, the indication that the one or more user interface elements corresponding to the setting are being displayed is sent to the application from the second system process using an API of the second system process, such as an API to create a second object (e.g., 304 or 306) to execute in the application process of the application. In some embodiments, the second object sends and/or receives data and/or requests between the application process and the second system process. In some embodiments, the indication that the one or more user interface elements corresponding to the setting are being displayed is sent to the application from the second system process using an API of the second system process, such as an API to communicate between the second system process and the application. In some embodiments, while the user interface and the one or more user interface elements are being displayed, the application receives, from the first system process, an indication (e.g., 350) that the setting corresponding to the user interface has been changed from a fourth state (e.g., the third state or another state different from the third state) to a fifth state on behalf of the application without the application requesting the setting to be changed, wherein the fifth state is different from the fourth state. In some embodiments, the indication that the setting corresponding to the user interface has been changed from the fourth state is sent to the application from the first system process using an API of the first system process, such as an API to create a second object to execute in the application process of the application. In some embodiments, the second object sends and/or receives data and/or requests between the application process and the first system process. In some embodiments, the indication that the setting corresponding to the user interface has been changed from the fourth state is sent to the application from the first system process using an API of the first system process, such as an API to notify the application of changes to the setting.

In some embodiments, the application does not notify the system process that the setting was changed from the second state to the third state (e.g., as described above with respect to FIG. 3B). In some embodiments, the other system process (e.g., a system process that manages the setting) notifies the system process that the setting was changed from the second state to the third state.

In some embodiments, in response to receiving the indication that the setting corresponding to the user interface has been changed from the first state to the second state on behalf of the application without the application requesting the setting to be changed, the application changes display of, via the one or more display generation components, the user interface (e.g., as described above with respect to FIG. 3B). In some embodiments, display of the user interface is changed via the system process or another system process different from the system process. In some embodiments, display of the user interface is changed using an API of the system process, such as an API to create a first object to execute in an application process of the application. In some embodiments, the first object sends and/or receives data and/or requests between the application process and the system process. In some embodiments, display of the user interface is changed using an API of the system process, such as an API to change what is being displayed.

In some embodiments, in response to detecting the input corresponding to the request to change the setting, the application changes display of, via the one or more display generation components, the user interface (e.g., as described above with respect to FIG. 3B). In some embodiments, display of the user interface is changed via the system process or another system process different from the system process. In some embodiments, display of the user interface is changed using an API of the system process, such as an API to create a first object to execute in an application process of the application. In some embodiments, the first object sends and/or receives data and/or requests between the application process and the system process. In some embodiments, display of the user interface is changed using an API of the system process, such as an API to change what is being displayed.

Note that details of the processes described above with respect to process 600 (e.g., FIG. 6) are also applicable in an analogous manner to other processes described herein. For example, process 500 optionally includes one or more of the characteristics of the various processes described above with reference to process 600. For example, the system process of process 600 can be the first process of process 500. For brevity, these details are not repeated herein.

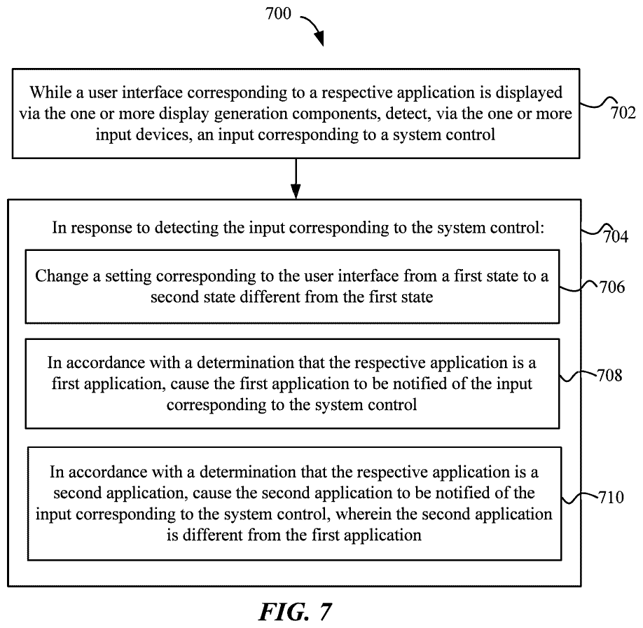

FIG. 7 is a flow diagram illustrating a process (e.g., process 700) for updating settings in accordance with some embodiments. Some operations in process 700 are, optionally, combined, the orders of some operations are, optionally, changed, and some operations are, optionally, omitted.

As described below, process 700 provides an intuitive way for updating settings. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a device (e.g., 300), by a system process (e.g., an overlay process, a control process, a system control process, a hardware daemon, an input device daemon, an output device daemon, a sensor daemon, the second system process of process 400, the first system process of process 400, and/or the system process of process 600) (e.g., 308) of the device, that is in communication with (and/or includes) one or more display generation components (e.g., a display screen, a projector, a head mounted display, and/or a touch-sensitive display) and one or more input devices (e.g., a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface). In some embodiments, the device is a watch, a phone, a tablet, a fitness tracking device, a processor, a head-mounted display (HMD) device, a communal device, a media device, a speaker, a television, an electronic device, and/or a personal computing device. In some embodiments, the system process is part of and/or executing on behalf of an operating system of the device. In some embodiments, the system process facilitates communication between one or more applications of the device and one or more hardware components of the device. In some embodiments, the system process manages a system control that is able to change one or more settings of the application and/or the device. In some embodiments, an input device of the one or more input devices is a camera, a depth sensor, a microphone, a hardware input mechanism, a rotatable input mechanism, a physical input mechanism, a mechanical button, a touch-sensitive button, a button, a crown, a knob, a dial, a physical slider, an accelerometer, a mouse, a keyboard, a touchpad, and/or a touch-sensitive surface. In some embodiments, the input device is able to detect a mechanical press, a tap, a swipe, a tape and hold, a long hold, a short hold, and/or other touch-based gestures.

While a user interface (e.g., as described above with respect to FIGS. 3A-3B) corresponding to a respective application (e.g., a camera application, a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) (e.g., 302) is displayed via the one or more display generation components, the system process detects (702), via the one or more input devices, an input (e.g., a button press, a tap input, and/or a swipe input) (e.g., 346) corresponding to a system control (e.g., a control managed by the operating system of the device, such as a hardware control and/or a software control). In some embodiments, the user interface corresponding to the respective application is a user interface of the respective application. In some embodiments, the user interface corresponding to the respective application is not a user interface of the respective application but rather a user interface of another application and/or a system process of the device different from the respective application of the device. For example, the user interface corresponding to the respective application can be a camera user interface that is displayed from a user interface of the respective application for assisting with operation of the application. In some embodiments, the system control is not managed by the respective application. In some embodiments, the system controls is displayed on top of the user interface corresponding to the respective application.

In response to (704) detecting the input corresponding to the system control, the system process changes (706) (e.g., via the respective application or via another system process (e.g., 312), different from the system process, without being via the respective application) (e.g., 348) a setting (e.g., as described above with respect to FIGS. 3A-3B) corresponding to the user interface from a first state to a second state different from the first state. In some embodiments, the setting is shared between multiple applications, such as when multiple applications use a camera and the setting corresponds to a zoom and/or an exposure of the camera. In some embodiments, the setting is changed from the first state to the second state using an API of the system process, the respective application, or another system process (e.g., the first system process or the second system process as described above with respect to process 400, process 500, and/or process 600), different from the system process, such as an API to create a second object (e.g., 336) to execute in the system process or an application process of the respective application. In some embodiments, the second object sends and/or receives data and/or requests between the system process and the respective application and/or the other system process. In some embodiments, the setting is changed from the first state to the second state using an API of the system process, the respective application, or the other system process, such as an API to configure the system process to be able to change a state of the setting.

In response to (704) detecting the input corresponding to the system control, in accordance with a determination that the respective application is a first application, the system process causes (708) (e.g., 348) the first application to be notified (e.g., 350) of the input corresponding to the system control. In some embodiments, causing the first application to be notified of the input corresponding to the system control includes sending, to the first application, an indication of the second state. In some embodiments, causing the first application to be notified of the input corresponding to the system control includes changing, via the first application, the setting corresponding to the user interface from the first state to the second state. In some embodiments, causing the first application to be notified of the input corresponding to the system control includes changing, via another system process, separate from the system process, without being via the first application, the setting corresponding to the user interface from the first state to the second state, causing the other system process to notify the first application that the setting has been changed to the second state. In some embodiments, the first application is caused to be notified using an API of the system process, the first application, or the other system process, such as an API to create a second object (e.g., 336 or 306) to execute in the system process or an application process of the respective application. In some embodiments, the second object sends and/or receives data and/or requests between the system process and the first application and/or the other system process. In some embodiments, the first application is caused to be notified using an API of the system process, the first application, or the other system process, such as an API to configure the system process to notify of a change to the setting.

In response to (704) detecting the input corresponding to the system control, in accordance with a determination that the respective application is a second application, the system process causes (710) (e.g., 348) the second application to be notified (e.g., 350) of the input corresponding to the system control, wherein the second application is different from the first application. In some embodiments, causing the second application to be notified of the input corresponding to the system control includes sending, to the second application, an indication (e.g., 348 or 350) of the second state. In some embodiments, causing the second application to be notified of the input corresponding to the system control includes changing, via the second application, the setting corresponding to the user interface from the first state to the second state (e.g., as described above with respect to FIG. 3B). In some embodiments, causing the second application to be notified of the input corresponding to the system control includes changing, via another system process (e.g., 312), separate from the system process, without being via the second application, the setting corresponding to the user interface from the first state to the second state, causing the other system process to notify (e.g., 350) the second application that the setting has been changed to the second state. In some embodiments, the second application is caused to be notified using an API of the system process, the second application, or the other system process, such as an API to create a second object (e.g., 336 or 306) to execute in the system process or an application process of the respective application. In some embodiments, the second object sends and/or receives data and/or requests between the system process and the second application and/or the other system process. In some embodiments, the first application is caused to be notified using an API of the system process, the second application, or the other system process, such as an API to configure the system process to notify of a change to the setting.

In some embodiments, causing the first application to be notified of the input corresponding to the system control includes directly notifying (e.g., not via another system process and/or not via another application different form the first application) the first application of the input corresponding to the system control. In some embodiments, causing the second application to be notified of the input corresponding to the system control includes directly notifying (e.g., not via another system process and/or not via another application different form the first application) the second application of the input corresponding to the system control (e.g., as described above with respect to FIGS. 3A-3B).

In some embodiments, the first application is notified (e.g., 350) of the input via another system process (e.g., a hardware daemon, an input device daemon, an output device daemon, and/or a sensor daemon, and/or the first system process of process 400) (e.g., 312) different from the system process. In some embodiments, the second application is notified of the input via the system process.

In some embodiments, before detecting the input corresponding to the system control (and/or before or while the user interface is displayed), the system process receives, from the respective application, permission (e.g., 316) to change a state of the setting. In some embodiments, a state of the setting is managed by another system process different from the system process. In some embodiments, the system process is not able to change a state of the setting itself and/or without communicating with another system process different from the system process. In some embodiments, the system process is not able to change a state of the setting without receiving the permission for the system process to change a state of the setting. In some embodiments, the permission for the system process to change a state of the setting is sent to the system process from the respective application using an API of the system process, such as an API to create a second object (e.g., 304) to execute in an application process of the respective application. In some embodiments, the second object sends and/or receives data and/or requests between the application process and the system process. In some embodiments, the permission for the system process to change a state of the setting is sent to the system process from the respective application using an API of the system process, such as an API to configure the system process to be able to change a state of the setting.

In some embodiments, the setting is a first setting. In some embodiments, while the user interface is displayed, the system process receives, from the respective application, permission to change a state of a second setting different from the first setting (e.g., as described above with respect to FIG. 3B). In some embodiments, the second setting corresponds to the user interface. In some embodiments, a state of the second setting is managed by another system process different from the system process. In some embodiments, the system process is not able to change a state of the second setting itself and/or without communicating with another system process different from the system process. In some embodiments, the system process is not able to change a state of the second setting without receiving the permission for the system process to change a state of the second setting. In some embodiments, the permission for the system process to change a state of the second setting is sent to the system process from the respective application using an API of the system process, such as an API to create a second object (e.g., 304) to execute in an application process of the respective application. In some embodiments, the second object sends and/or receives data and/or requests between the application process and the system process. In some embodiments, the permission for the system process to change a state of the second setting is sent to the system process from the respective application using an API of the system process, such as an API to configure the system process to be able to change a state of the second setting. In some embodiments, after receiving the permission to change the state of the second setting (and/or while the user interface is displayed), the system process detects, via the one or more input devices, another input corresponding to the system control. In some embodiments, in response to detecting the other input corresponding to the system control, the system process changes (e.g., via the respective application or via another system process, different from the system process, without being via the respective application) the second setting from a state to another state different from the state. In some embodiments, in response to detecting the other input corresponding to the system control, the system process causes the respective application to be notified of the other input.

In some embodiments, in response to detecting the input corresponding to the system control (and/or while the user interface corresponding to the respective application is displayed), the system process displays, via the one or more display generation components, a representation (e.g., a user interface element, a system user interface element, a scale, an identification, and/or an indication) of the setting (e.g., as described above with respect to FIGS. 3A-3B). In some embodiments, the representation of the setting includes an indication of a current state of the setting. In some embodiments, the representation of the setting is displayed with and/or on top of the user interface. In some embodiments, the representation of the setting includes an indication of a current value of the setting.

In some embodiments, in response to displaying the representation of the setting (and/or in response to detecting the input corresponding to the system control and/or while the user interface corresponding to the respective application is displayed), the system process sends, to the respective application, a notification that the representation is being displayed (e.g., as described above with respect to FIGS. 3A-3B). In some embodiments, the notification that the representation is being displayed is sent to the respective application from the system process using an API of the system process, such as an API to create a second object to execute in the application process of the application. In some embodiments, the second object sends and/or receives data and/or requests between the application process and the system process. In some embodiments, the notification that the representation is being displayed is sent to the respective application from the system process using an API of the system process, such as an API to communicate between the system process and the respective application.

In some embodiments, in response to detecting the input corresponding to the system control (and/or while the user interface corresponding to the respective application is displayed), in accordance with the determination that the respective application is the first application, the system process forgoes cause of the second application to be notified of the input corresponding to the system control (e.g., as described above with respect to FIG. 3B). In some embodiments, in response to detecting the input corresponding to the system control, in accordance with the determination that the respective application is the second application, the system process forgoes cause of the first application to be notified of the input corresponding to the system control (e.g., as described above with respect to FIG. 3B).

In some embodiments, the input is a first input. In some embodiments, the setting is a first setting. In some embodiments, while the user interface corresponding to the respective application is displayed, the system process detects, via the or more input devices, a second input (e.g., the first input or another input different and/or separate from the first input) corresponding to the system control (e.g., as described above with respect to FIG. 3B). In some embodiments, in response to detecting the second input corresponding to the system control, in accordance with a determination that the system control currently corresponds to a second setting, the system process changes, via the respective application, the second setting (e.g., from a state to another state different from the state) (e.g., as described above with respect to FIG. 3B). In some embodiments, the second setting is the first setting. In some embodiments, the second setting is different from the first setting. In some embodiments, the second setting is changed using an API of the system process, the respective application, or another system process (e.g., the first system process or the second system process as described above with respect to process 400, process 500, and/or process 600), different from the system process, such as an API to create a second object to execute in an application process of the respective application. In some embodiments, the second object sends and/or receives data and/or requests between the system process and the respective application and/or the other system process. In some embodiments, the second setting is changed using an API of the system process, the respective application, or the other system process, such as an API to configure the system process to be able to change a state of the second setting. In some embodiments, in response to detecting the second input corresponding to the system control, in accordance with a determination that the system control currently corresponds to a third setting (e.g., and not the second setting), the system process changes, via another system process (e.g., the first system process or the second system process as described above with respect to process 400, process 500, and/or process 600) and not via the respective application, the third setting (e.g., from a state to another state different from the state) without changing the second setting (e.g., as described above with respect to FIG. 3B), wherein the third setting is different from the second setting (and/or the first setting), and wherein the other system process is different from the system process. In some embodiments, the third setting is changed using an API of the system process or the other system process, such as an API to create a second object to execute in the system process. In some embodiments, the second object sends and/or receives data and/or requests between the system process and the other system process. In some embodiments, the third setting is changed using an API of the system process or the other system process, such as an API to configure the system process to be able to change a state of the third setting.

In some embodiments, the system control is a hardware control (e.g., a hardware input mechanism, a rotatable input mechanism, a physical input mechanism, a mechanical button, a touch-sensitive button, a button, a crown, a knob, a dial, a physical slider, a keyboard, a touchpad, and/or a touch-sensitive surface) (e.g., as described above with respect to FIGS. 3A-3B). In some embodiments, the hardware control is able to detect a mechanical press, a tap, a swipe, a tape and hold, a long hold, a short hold, and/or other touch-based gestures.

In some embodiments, the user interface corresponding to the first application is different from the user interface corresponding to the second application (e.g., as described above with respect to FIG. 3B).

In some embodiments, the setting is a first setting. In some embodiments, the input is a first input. In some embodiments, while the user interface is displayed (and/or after detecting the first input corresponding to the system control), the system process detects, via the one or more input devices, a second input (e.g., a button press, a tap input, and/or a swipe input) corresponding to the system control, wherein the second input is separate from the first input (e.g., as described above with respect to FIG. 3B). In some embodiments, in response to detecting the second input corresponding to the system control, the system process changes (e.g., via the respective application or via another system process, different from the system process, without being via the respective application) a third setting from a state to another state different from the state, wherein the third setting is different from the first setting (e.g., as described above with respect to FIG. 3B). In some embodiments, the third setting is changed from the state to the other state using an API of the system process, the respective application, or another system process (e.g., the first system process or the second system process as described above with respect to process 400, process 500, and/or process 600), different from the system process, such as an API to create a second object to execute in the system process or an application process of the respective application. In some embodiments, the second object sends and/or receives data and/or requests between the system process and the respective application and/or the other system process. In some embodiments, the third setting is changed from the state to the other state using an API of the system process, the respective application, or the other system process, such as an API to configure the system process to be able to change a state of the third setting. In some embodiments, after detecting the first input corresponding to the system control and before detecting the second input corresponding to the system control, the system process receives a request to change the system control from changing the first setting to changing the third setting. In some embodiments, in response to detecting the second input corresponding to the system control, the system process causes the respective application to be notified of the second input (e.g., as described above with respect to FIG. 3B). In some embodiments, the respective application is caused to be notified using an API of the system process, the respective application, or the other system process, such as an API to create a second object to execute in the system process or an application process of the respective application. In some embodiments, the second object sends and/or receives data and/or requests between the system process and the respective application and/or the other system process. In some embodiments, the respective application is caused to be notified using an API of the system process, the respective application, or the other system process, such as an API to configure the system process to notify of a change to the third setting.

In some embodiments, the system process has a more limited range that the system process can modify the setting as compared to the respective application (e.g., as described above with respect to FIGS. 3A-3B). In some embodiments, before or in response to detecting the input corresponding to the system control, the system process sends, to another system process (e.g., the first system process or the second system process as described above with respect to process 400, process 500, and/or process 600) different from the system process, a request for one or more characteristics and/or attributes (e.g., a range, a step amount, and/or a set of multiple values) of the setting. In some embodiments, after sending the request for the range of the setting, the system process receives the one or more characteristics and/or attributes of the setting. In some embodiments, sending the request for the one or more characteristics and/or attributes of the setting and/or receiving the one or more characteristics and/or attributes of the setting is performed via an API of the other system process. In some embodiments, changing the setting corresponding to the user interface includes changing the setting within a smaller range and/or a lesser number of the set of multiple values than defined in the one or more characteristics and/or attributes of the setting (e.g., the system process is not allowed to change the setting as much and/or to certain states that the respective application is allowed to change the setting to).

Note that details of the processes described above with respect to process 700 (e.g., FIG. 7) are also applicable in an analogous manner to the processes described herein. For example, process 400 optionally includes one or more of the characteristics of the various processes described herein with reference to process 700. For example, the system process of process 700 can be the second process of process 400. For brevity, these details are not repeated herein.

In some embodiments, one or more of processes 400, 500, 600, and 700 (FIGS. 4, 5, 6, and 7) is performed at a first computer system (as described herein) via a system process (e.g., an operating system process and/or a server system process) that is different from one or more applications executing and/or installed on the first computer system.

In some embodiments, one or more of processes 400, 500, 600, and 700 (FIGS. 4, 5, 6, and 7) is performed at a first computer system (as described herein) by an application that is different from a system process.

In some embodiments, the instructions of the application, when executed, control the first computer system to perform one or more of processes 400, 500, 600, and 700 (FIGS. 4, 5, 6, and 7) by calling an application programming interface (API) provided by the system process. In some embodiments, the application performs at least a portion of one or more of processes 400, 500, 600, and 700 (FIGS. 4, 5, 6, and 7) without calling the API.

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform one or more of processes 400, 500, 600, and 700 (FIGS. 4, 5, 6, and 7) by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, processes, procedures, data structures, classes, and/or other services provided by a set of implementation instructions of the system process. The API can define one or more parameters that are passed between the API calling instructions and the implementation instructions.

As described above, in some embodiments, an application controls a computer system to perform processes 400, 500, 600, and 700 (FIGS. 4, 5, 6, and 7) by calling an application programming interface (API) provided by a system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, API 176 defines a first API call that can be provided by API calling instructions 174, wherein the definition for the first API call specifies call parameters described above with respect to processes 400, 500, 600, and 700 (FIGS. 4, 5, 6, and 7).

In some embodiments, API 176 defines a first API call response that can be provided to an application by API calling instructions 174, wherein the first API call response includes parameters described above with respect to processes 400, 500, 600, and 700 (FIGS. 4, 5, 6, and 7).

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call.

In some embodiments, the set of implementation instructions is included in the device (e.g., 168) that runs the application. In some embodiments, the set of implementation instructions is included in an electronic device that is separate from the device that runs the application.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the techniques and their practical applications. Others skilled in the art are thereby enabled to best utilize the techniques and various examples with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve how a device interacts with a user. The present disclosure contemplates that in some instances, this gathered data can include personal information data that uniquely identifies or can be used to contact or locate a specific person. Such personal information data can include demographic data, location-based data, telephone numbers, email addresses, home addresses, or any other identifying information.

The present disclosure recognizes that the use of such personal information data, in the present technology, can be used to the benefit of users. For example, the personal information data can be used to change how a device interacts with a user. Accordingly, use of such personal information data enables better user interactions. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of image capture, the present technology can be configured to allow users to select to “opt in” or “opt out” of participation in the collection of personal information data during registration for services.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be displayed to users by inferring location based on non-personal information data or a bare minimum amount of personal information, such as the content being requested by the device associated with a user or other non-personal information.

What is claimed is:

1. A method, comprising:
at a device, by an application of the device, that is in communication with one or more display generation components and one or more input devices:
while a user interface corresponding to the application is displayed via the one or more display generation components, detecting, via the one or more input devices, an input; and
in response to detecting the input:
sending, to a first system process of the device, a first notification of the input, wherein the first system process is separate from the application; and
sending, to a second system process of the device, a second notification of the input, wherein the second system process is separate from the first system process and the application, and wherein the second notification is separate from the first notification.

2. The method of claim 1, wherein the first notification of the input includes a request to change a setting corresponding to the user interface.

3. The method of claim 1, wherein the second notification of the input includes an indication of a result of the input.

4. The method of claim 1, wherein the input corresponds to a request to change a setting corresponding to the user interface, the method further comprising:
before detecting the input, sending, to the second system process of the device, permission for the second system process to change a state of the setting on behalf of the application.

5. The method of claim 4, further comprising:
after sending the permission for the second system process to change a state of the setting, receiving, from the second system process, a first request to change the setting; and
in response to receiving the request to change the setting, sending, to the first system process, a second request to change the setting in accordance with the first request to change the setting.

6. The method of claim 5, wherein the input is a first input, the method further comprising:
after sending the second request to change the setting, sending, to the second system process, a request to remove permission for the second system process to change a state of the setting;
after sending the request to remove permission for the second system process to change a state of the setting, detecting, via the one or more input devices, a second input; and
in response to detecting the second input, sending, to the first system process of the device, a notification of the second input without sending, to the second system process of the device, a notification of the second input.

7. The method of claim 4, wherein the permission for the second system process to change a state of the setting is sent in response to detecting a request to display the user interface.

8. The method of claim 1, wherein the input is a first input, the method further comprising:
after detecting the first input, detecting, via the one or more input devices, a third input, wherein the third input is separate from the first input; and
in response to detecting the third input:
in accordance with a determination that the third input corresponds to a first setting, sending, to the first system process of the device, a first notification of the third input without sending, to the second system process of the device, a notification of the input; and
in accordance with a determination that the third input corresponds to a second setting:
sending, to the first system process of the device, the first notification of the third input, wherein the second setting is different from the first setting; and
sending, to the second system process of the device, a second notification of the third input, and wherein the second notification of the third input is separate from the first notification of the third input.

9. The method of claim 1, wherein the input corresponds to a request to change a zoom level of a camera.

10. The method of claim 1, wherein the input corresponds to a request to change an exposure level of a camera.

11. The method of claim 1, wherein the input corresponds to a request to change a filter applied to content captured via a camera.

12. The method of claim 1, wherein the input corresponds to a request to modify a user interface element of the application.

13. The method of claim 1, wherein the input corresponds to a setting, the method further comprising:
while the user interface is being displayed, receiving, from the second system process, an indication that one or more user interface elements corresponding to the setting are being displayed, wherein the one or more user interface elements are managed by the second system process;
while the user interface and the one or more user interface elements are being displayed, receiving, from the second system process, a first request to change the setting, wherein the first request to change the setting corresponds to an input being detected that corresponds to the one or more user interface elements; and
in response to detecting the first request to change the setting, sending, to the first system process, a second request to change the setting in accordance with the first request to change the setting.

14. The method of claim 13, further comprising:
while the user interface is being displayed and in response to receiving the indication that the one or more user interface elements corresponding to the setting are being displayed, changing display of, via the one or more display generation components, the user interface.

15. The method of claim 13, further comprising:
while the user interface is being displayed and after receiving the indication that the one or more user interface elements corresponding to the setting are being displayed, receiving, from the second system process, an indication that the one or more user interface elements corresponding to the setting are no longer being displayed.

16. The method of claim 1, further comprising:
in response to detecting the input, changing display of, via the one or more display generation components, the user interface.

17. A non-transitory computer-readable storage medium storing one or more programs configured to be executed by one or more processors of a device, by an application of the device, that is in communication with one or more display generation components and one or more input devices, the one or more programs including instructions for:
while a user interface corresponding to the application is displayed via the one or more display generation components, detecting, via the one or more input devices, an input; and
in response to detecting the input:
sending, to a first system process of the device, a first notification of the input, wherein the first system process is separate from the application; and
sending, to a second system process of the device, a second notification of the input, wherein the second system process is separate from the first system process and the application, and wherein the second notification is separate from the first notification.

18. A device, by an application of the device, configured to communicate with one or more display generation components and one or more input devices, the device comprising:
one or more processors; and
memory storing one or more programs configured to be executed by the one or more processors, the one or more programs including instructions for:
while a user interface corresponding to the application is displayed via the one or more display generation components, detecting, via the one or more input devices, an input; and
in response to detecting the input:
sending, to a first system process of the device, a first notification of the input, wherein the first system process is separate from the application; and
sending, to a second system process of the device, a second notification of the input, wherein the second system process is separate from the first system process and the application, and wherein the second notification is separate from the first notification.
